(19) United States
(12) Patent Application Publication
(10) Pub. No.: US 2005/0014486 A1
(43) Pub. Date: Jan. 20, 2005

(54) Information providing system

(76) Inventors: Atsushi Shimizu, Kyoto (JP); Tanichi Ando, Kyoto (JP); Masaki Yamato, Kyoto (JP); Nobuyuki Sakatani, Kyoto (JP)

Correspondence Address: FOLEY AND LARDNER;SUITE 500, 3000 K STREET NW, WASHINGTON, DC, 20007, US

(21) Appl. No.: 10/488,861

(22) PCT Filed: Sep. 6, 2002
(86) PCT No.: PCT/JP02/09088

(30) Foreign Application Priority Data
Sep. 6, 2001 (JP) 2001-270888

(51) Int. Cl. H04Q 7/20

(52) U.S. Cl. 455/412.1; 455/412.2; 455/432.1

(57) ABSTRACT

The object of this invention is to collect a data without using a specialized system such as sensor terminals and provide a data to a terminal device. The information provision system according to this invention is provided with fixed data transmitters and sensing data transmitters. When terminal device 23 moves into a predetermined space (sensor field), the terminal device receives a predetermined fixed data from the fixed data transmitter, and/or a sensing data obtained by sensing from the sensing data transmitter. The terminal device then transmits these received data to data processing server 21 along with a process request via a network. The data processing server can execute a processing based on these received data and the process request, and generate a process data in order to provide for the terminal device.

### FIELD OF TECHNOLOGY

The present invention relates to a terminal device, such as a mobile terminal device that is used to access any of a variety of information provision services providing specified fixed data (data) such as positional data and/or sensing data collected by various information collection centers, a data processing server that is used in conjunction with this terminal device, and an information provision system that uses this information provision server; in particular, it relates to an information provision system and information provision method that are based upon the receipt of acquired information by the terminal device of fixed data and/or sensing data, and a data processing server that processes that acquired information and generates the processed data on the terminal device. It further relates to the program and program media.

### BACKGROUND TECHNOLOGY

In recent years, the development of mobile information terminal devices such as transportable terminal devices (e.g. portable telephones and PDAs) has allowed users to want access to various information provision services wherever they happen to be. In other words, there is a need for mobile terminal devices to be able to use information provision services irrespective of their location.

In general, with such information provision services, a data processing server is connected with a specialized system to collect the information, and the data processing server uses this specialized system to collect various types of information. Then, the data processing server is accessed by the mobile terminal device to see the required information.

For example, in a road traffic information system, the data processing server would collect sensing data on vehicular traffic using sensors or another type of specialized system, and then based upon this sensing data, would determine the road traffic situation for each local area. Then, the mobile terminal device would be able to reference this road traffic status information.

At this point, an example of a conventional information provision system will be explained with reference to FIG. 33.

In the example of the Figure, the data processing server 11 collects sensing data that is obtained for the object being sensed through a specialized system. The specialized system is comprised of sensor terminal 12 and a plurality of various types of sensors 13. The sensing data collected by the various types of sensors 13 is collected in the data processing server 11 via sensing terminal 12. The terminal device (e.g. mobile terminal device 14) is connected with a base station (not shown) and a network (e.g. the Internet) 15 to data processing server 11. The data processing server 11, can access the processing results (processed data) based upon the sensing data. The mobile terminal device 14 depicted in FIG. 33 has the capability to display to the user or notify the user of processing results based on its communications and signal reception functions.

The information provision system diagrammed in FIG. 33 can be used when the various sensors 13 are not too distant from the data processing server 11. If the data processing server is to collect sensing data from a remote object being sensed, then it is necessary to have network 16 disposed between the data processing server 11 and the sensing terminal 12 as is shown in FIG. 34.

In other words, when the data processing server 11 is to obtain sensing data remotely, rather than by connecting sensor terminal 12 with data processing server 11 via a dedicated line, the connection via network 16 between data processing server 11 and sensor terminal 12 makes it possible to collect the sensing data less expensively. This network 16 may be the same network as network 15.

When the data processing server 11 and the sensor terminal 12 are connected via network 16, it is necessary for information server 11 and sensor terminal 12 to both be connected to network 16 via its standard connection method. It is further necessary at sensor terminal 12 to have ID processing (ID acquisition) to distinguish the various types of sensors 13, and to perform its processing in synch with network 16.

Thus, when network 16 is used to acquire sensing data, as is shown in FIG. 35, sensor terminal 12 must have a network support function 12a, a data notification function 12b, a sensor connection function 12c and a sensor surveillance function 12d. The network support function 12a maintains a connected state with data processing server 11 via network 16, and it performs processing for the purposes of communications (for example to reduce network traffic, etc.) The sensor connection function 12c maintains a connections with sensors 13.

The sensor surveillance function 12d oversees the types and the operational states for sensors 13, and passes sensing requirements to them from the data processing server and, using the data notification function 12b, gives sensor surveillance information to data processing server 11. On the other hand, when a sensing requirement is generated from data processing server 11, the information notification function 12b is used to send the sensing data to the data processing server.

When the sensor terminal 12 is located in relative close proximity to sensors 13 and when the information server tries to acquire sensing data from sensors located in a large number of places, a plurality of sensor terminals would be required. Further, since there are limitations upon the number of sensors that may be connected to each sensor terminal 12, if the number of sensors is increased to beyond that limit, it is also necessary to increase the number of sensor terminals.

To wit, as shown in FIG. 36, the first through third sensor terminals 12-1, through 12-3 are connected via network 16; it comprises a distributed system in which sensors 13 are connected to the first through third sensor terminals 12-1 through 12-3.

As described above, in cases where the object being sensed is remotely located, it is generally necessary to employ a network 16 between data processing server 11 and sensor terminal 12. This has the inherent problem of the sensor terminal itself being a high cost item. When using a distributed system, as a result of the requirement to increase the number of sensor terminals in use, such an information provision system itself can become very expensive.

On the other hand, striving to reduce the number of sensor terminals often results in increasing the number of sensors served by a single server terminal, and the more centralized the system becomes (the fewer the number of sensor terminals), there is the problem of an even greater the load being imposed upon the sensor terminal.

In addition, despite there being limited data processing requirements for the mobile terminals devices, considering the a large number of mobile terminal devices, the data processing server 11 must oversee and collect the data from all of the sensor terminals (or sensors). Thus, data processing server 11 must constantly oversee the sensor terminals (or sensors), and as the number of sensors increases, so does the surveillance load upon the data processing server, and it may increase to the point its regular processing functions are compromised.

If configuring an information provision system with the foregoing problems areas in mind, it would be necessary to configure a specialized system based upon the type of sensors (in other words, the type of sensing data), but that would then create the further problem as a direct result, that other information provision systems could not use the same specialized system because the type of sensors would be different. In other words, the problem with the prior art information provision systems was that they lacked universality. For example, a traffic information provision system would be difficult to use as is with another type of information provision system.

Further, when using a connection to network 16, if there were a large number of sensors 13 in close proximity, such systems required each individual (user) to manage his own sensors 13, which often created a sense of psychological oppression. With the system depicted in FIG. 37, sensor 13 (shown as a “sensing equipment”) had a data sensing function 13a and an information transmitting function 13b. This sensor 13 was connected to data processing server 11 via network 16. The sensor 13 would use its data sensing function in order to obtain sensing data for the user by sensing the object of the sensing, and then its information transmitting function 13b would be used to send the user sensing data to data processing server 11 via network 16. In other words, data processing server 11 collected the user sensing data from the sensor 13.

In a building, for example, the sensing equipment 13 could be surveillance cameras, etc. installed in the building and data processing server 11 would be the surveillance Center (this surveillance Center could surveille a plurality of facilities as well). In this type of system, when a user discovered the sensing equipment 13 (step P1) or when user activity information was collected at data processing server 11 (surveillance Center) (step P2), he would have the feeling that he himself was being surveilled (step P3), which would mean that the user would have the unpleasant feeling of being subjected to surveillance (step P4). This would generate the idea of refusal behavior in his mind (step P5) and the user would act out that behavior (step P6, for example, to exit the area).

Thus, if the objects of the sensing were all people, such as users, when the users found that they were under surveillance, an unpleasant feeling would develop, and in many cases, the users would attempt somehow to prevent that surveillance. In any case, as shown in the system depicted in FIG. 37, information was being collected (such as information on their actions) that was against the will of the individuals, users, etc., involved. In other words, the users would not utilize the sensing data because it was collected against their will.

### DISCLOSURE OF THE INVENTION

The objective of the present invention is to provide a terminal device which collects information without a requirement for a sensor terminal, a data processing server to use in conjunction with this terminal device, an information provision system using this data processing server, and a method of information provision.

An additional objective of the present invention is to provide a terminal device with excellent universality, a data processing server to use in conjunction with this terminal device, an information provision system using this data processing server, and a method of information provision.

Another objective of the present invention is to provide an information provision system that reduces the load on the data processing server and an information provision method.

Yet another objective of the present invention is to provide a program and a program media that will satisfy the foregoing objectives.

The present invention provides a terminal device, which is characterized in that it is equipped with a terminal transmission means that can transmit, via a network to a data processing server, sensing data it has acquired from receipt the sensing data comprising pre-specified fixed data and/or sensed physical phenomena or physical quantities; and a terminal reception means that can receive processed data based upon the foregoing acquired data from the foregoing data processing server.

In this manner, the terminal device sends acquired data to a data processing server, and after it generates processed data, allows an appropriately processed data to be obtained that is based upon the acquired data.

This terminal device is further equipped with a notification means that makes notifications on the foregoing data acquisition and the foregoing data processing, and when the foregoing acquired data is transmitted to the foregoing data processing server, in cases when the foregoing acquired data requires a special processing program to process it for transmission, a downloading means that allows the foregoing special processing program to request a download from the foregoing data processing server to thereby retrieve said processing program.

Further, the present invention provides a data processing server characterized in that it is equipped with a server reception means that can receive the foregoing acquired data from the foregoing terminal device, a server processing means that can generate processed data by processing the foregoing acquired data, and a server transmission means that can transmit said processed data to the foregoing terminal device.

Since the foregoing data processing server needs only to generate processed data based upon the acquired data from the terminal device, to wit, it needs only transmit to the terminal device, processed data based upon processing requests and its acquired data, the data processing server is not a specialized system such as a sensor terminal, it merely collects information. Thus, there is no need to use a specialized system, which thereby improves the universality of this system.

The data processing server also has a fee assessment means that enables the amount of the fee to be computed based upon the foregoing processed data and that fee information to be transmitted to the foregoing terminal device. The foregoing fee assessment means can accumulate the amounts of fees assessed by each of the foregoing terminal devices. Further, should the foregoing fee assessment means determine from the generation of the foregoing processed data that a fee is required, the amount of the fee will be notified in prior to the completion of the generation of the processed data and be sent to the terminal device.

Further, the foregoing server processor means, when generating the foregoing processed data based upon the acquired data and when a processing request is sent from the foregoing terminal device that information is required from another server to provide the requisite information, it may also generate the processed data that was based upon the aforementioned acquired data and the aforementioned required information.

In cases where the data processing server is requested by the foregoing terminal device for the foregoing download, it is equipped with a search means that searches the processing programs for the download program in response to the download request.

Further, the present invention provides an information provision system that is characterized in that it is equipped a fixed data transmitter that transmits pre-specified fixed data, a terminal device that receives the foregoing fixed data from the fixed data transmitter, which is located within a predetermined space, and then sends out the foregoing fixed data via a network as acquired data, and a data processing server which provides to the foregoing terminal device, processed data based upon the data acquired from the foregoing terminal and the processing request from the foregoing terminal device.

This information provision system may employ a terminal device that is installed or carried within the confines of a predetermined space that is equipped with a sensing data transmitter that can transmit sensing data acquired through the sensing of physical phenomena or physical quantities so that the foregoing terminal device may transmit that sensing data as the above described acquired data to the data processing server.

Thus, predetermined fixed data and/or sensing data may be transmitted from the data transmitter for receipt as fixed data by the terminal device, which exists within a predetermined space. Because this terminal device transmits this fixed data as acquired data via a network to the data processing server along with a processing request, the data processing server can generate processed data based upon the processing request and the acquired data and then transmit it back to the terminal device, which, as a result, allows the data processing sever to collect data without incorporating a specialized system such as a sensor terminal.

Also, the universality of the system is improved since there is no need for a specialized system. Further still, since there is no need to manage sensors or a sensor terminal, it is possible to reduce the load on the data processing server. In other words, it is only necessary for the data processing server to manage the acquired information that is sent from the terminal device, it does not need to manage all of the sensor data. To wit, only the information needed by the terminal device has to be managed.

The foregoing terminal device may be a first and a second terminal devices. The foregoing first terminal device would transmit the foregoing data processing request and additionally, the foregoing acquired data would be transmitted as the first set of acquired data. The aforementioned acquired data would be transmitted from the foregoing second terminal device as the second set of acquired data, and the data processing server, based upon the foregoing processing request and the foregoing first set of acquired data, would prepare processed data, which based upon the second set of acquired data would be transmitted to the foregoing second terminal device. The foregoing fixed data transmitter may be a mobile transmitter.

In addition, the present invention provides an information provision method characterized in that it is comprised of a first step in which a terminal device installed in a predetermined space receives. fixed data, a second step in which the foregoing terminal transmits the foregoing fixed data as acquired data via a network, and a third step in which the data processing server receives the foregoing acquired data, then generates processed data based upon the foregoing acquired data and the processing request from the foregoing terminal device, and provides that processed data to the foregoing terminal device.

In this manner, the data processing server need only to generate the processed data based upon the processing request and the acquired data, and then transmit it to the terminal device. As a result the data processing server does not need a specialized system such as a sensor terminal to perform its information collection. Not requiring a specialized system increases its universality.

Further, since the data processing server does not need to manage the sensors. and sensor terminal to measure physical phenomena or physical quantities, this can lower the load of the data processing server.

It would also be possible, as the foregoing first step, to have the foregoing terminal device receive transmissions of the sensing results of physical phenomena or physical quantities, and then in the second step, for the foregoing terminal device to transmit said sensing data as the acquired data to the foregoing data processing server.

In addition, the present invention discloses a data processing program for a computer which functions in a manner characterized in that a terminal transmission means obtains sensing results, received as acquired data, of predetermined fixed data and/or physical phenomena or physical quantities, which is transmitted via a network to the data processing server, and a terminal reception means to receive the processing results from the foregoing data processing server that processed the foregoing acquired information.

In this manner, the acquired data is transmitted to the data processing server to generate processed data, thereby making it possible to obtain appropriately processed data based upon the acquired data.

Further still, the present invention discloses a recordable media upon which a data processing program is recorded that is readable by a computer which is characterized in that, in a first step, a terminal device installed in a predetermined space in a computer receives a predetermined set fixed data, in a second step, the terminal device transmits the foregoing fixed data as acquired data via a network, and in a third step the data processing server receives the forgoing acquired data, and based upon that acquired data and the processing request from the foregoing terminal device, processes that data to generate processed data ,which is then sent to the foregoing terminal device.

By the use of such a recording medium in this invention, the data processing server needs only to generate processed information based upon the processing request and acquired data and then to transmit it to the terminal device. As a result, the data processing server can collect its data without requiring a sensing terminal or other specialized system. The universality of the system is improved because there is no need for such a specialized system.

### A BRIEF EXPLANATION OF THE DRAWINGS

FIG. 1 shows a block diagram of an example of an information provision system according to this invention.

FIG. 2 is a diagram showing the place (sensing field) from which the terminal device in use can acquire sensing data or fixed data.

FIG. 3 is a block diagram of the function of the sensing data transmitter; (a) a function block diagram of an active sensing data transmitter; (b) a function block diagram of a passive fixed data transmitter.

FIG. 4 is a block diagram showing the hardware configuration for a sensing data transmitter.

FIG. 5 is a block diagram of the function of the fixed data transmitter; (a) a function block diagram of an active fixed data transmitter, (b) a function block diagram of a passive fixed data transmitter.

FIG. 6 is a block diagram showing the hardware configuration of the fixed data transmitter.

FIG. 7 is a block diagram showing an example of the hardware configuration of the terminal device in use.

FIG. 8 is a block diagram showing an example of the hardware configuration of a data processing server.

FIG. 9 is a flow chart used to explain the operation of the passive sensing data transmitter.

FIG. 10 is a flow chart used to explain the operation of a passive type fixed data transmitter.

FIG. 11 is a flow chart used to explain the operation of a first example of the user terminal device of FIG. 7.

FIG. 12 is a flow chart used to explain the operation of a second example of the user terminal device of FIG. 7.

FIG. 13 is a flow chart used to explain the operation of a third example of the user terminal device of FIG. 7.

FIG. 14 is a flow chart used to explain the operation of a first example of the data processing server of FIG. 8.

FIG. 15 is a flow chart used to explain the operation of a second example of the data processing server of FIG. 8.

FIG. 16 is a flow chart used to explain the operation of a third example of the data processing server of FIG. 8.

FIG. 17 is an example of the screen display when the user terminal device is a wireless telephone, (a) is a menu of information about the present location, (b) is a figure showing that data is being received, and (c) is location information.

FIG. 18 is a figure showing an embodiment an information provision system according to this invention used to provide information about commuter train operations.

FIG. 19 is an example of the screen display of the system in FIG. 18 when the user terminal device is a wireless telephone, (a) shows the menu for commuter train arrivals, (b) is the menu for selecting the train line, (c) is a figure showing that sensing data is being received, (d) is a diagram showing that data is being transmitted to a Center, (e) is a diagram showing that data is being received from a Center, and (f) is a diagram showing the scheduled commuter train arrival.

FIG. 20 is a flow chart used to explain the operation of the system shown in FIG. 18.

FIG. 21 is an example of the screen display of another system example when the user terminal device is a wireless telephone, (a) a figure showing the function selection menu, (b) a diagram showing downloads are possible or not possible, (c) a diagram showing that a download is being requested, (d) a diagram showing that a program is being received, (e) a diagram showing a weather information menu for the destination area.

FIG. 22 is a figure used to explain the download of a program to acquire the weather information described in FIG. 21 for the destination location.

FIG. 23 shows the screen display on a wireless telephone of the acquired weather information, (a) a figure showing the fee, (b) a figure indicating information is being transmitted to the Center, (c) a diagram indicating that information is being received from the Center, (d) a display of weather information.

FIG. 24 is an example wherein the user terminal device is the vehicle itself.

FIG. 25 is a block diagram of the configuration of the terminal device of FIG. 24.

FIG. 26 is a block diagram of the configuration of the specialized equipment in the device/equipment of FIG. 25.

FIG. 27 is an example showing the user terminal device of FIG. 7 being used in conjunction with an in-vehicle LAN.

FIG. 28 is a diagram shown an example of the connections between the user terminal device of FIG. 27 with the connection area of the specialized device or equipment.

FIG. 29 is a figure showing when the user terminal device is installed in the portable telephone in the vehicle shown in FIG. 7.

FIG. 30 is a figure showing an example of a taxi dispatching system used as the information provision system of FIG. 1.

FIG. 31 is another example of a taxi dispatching system used as the information provision system of FIG. 1.

FIG. 32 shows an example of a bus operations management system used as the information provision system of FIG. 1.

FIG. 33 is a block diagram of an example of a conventional information provision system.

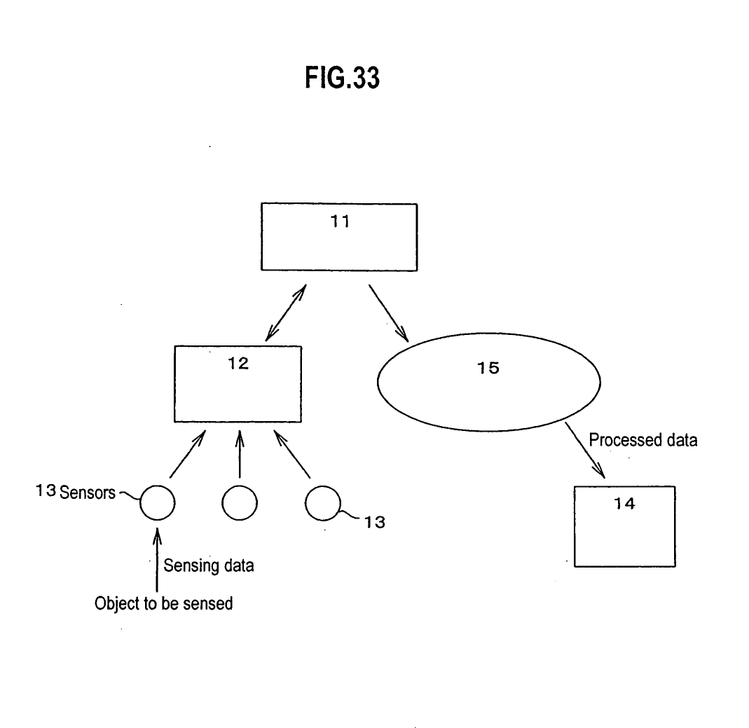

FIG. 34 is a diagram showing an example of a network connecting the data processing server and the sensor terminal in a conventional information provision system.

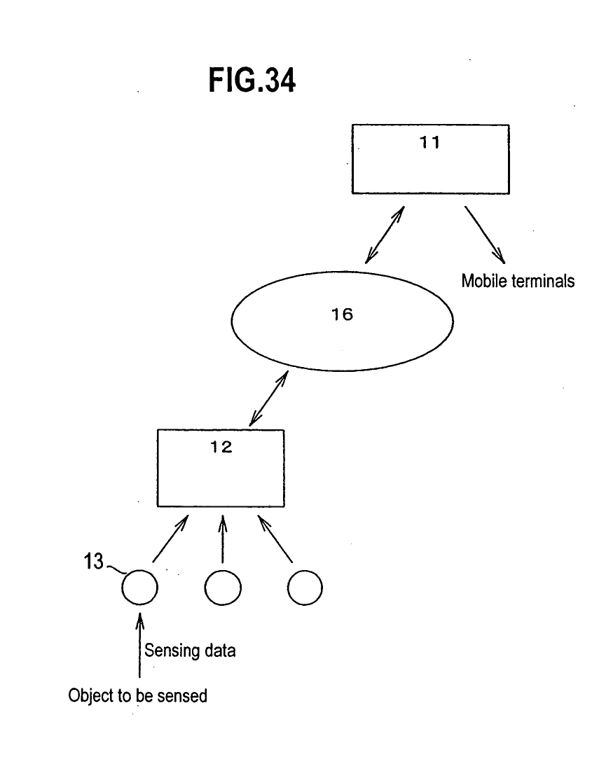

FIG. 35 is a block diagram used to describe the functions of the sensor terminal in a conventional information provision system.

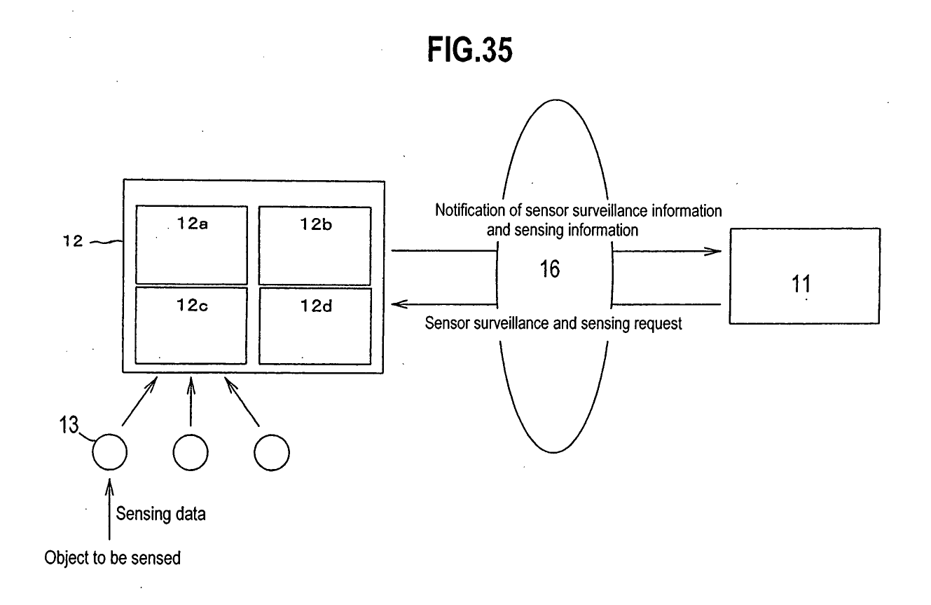

FIG. 36 is a diagram showing an example of the connection of a plurality of sensor terminals to an information provision server via a network in a conventional information provision system.

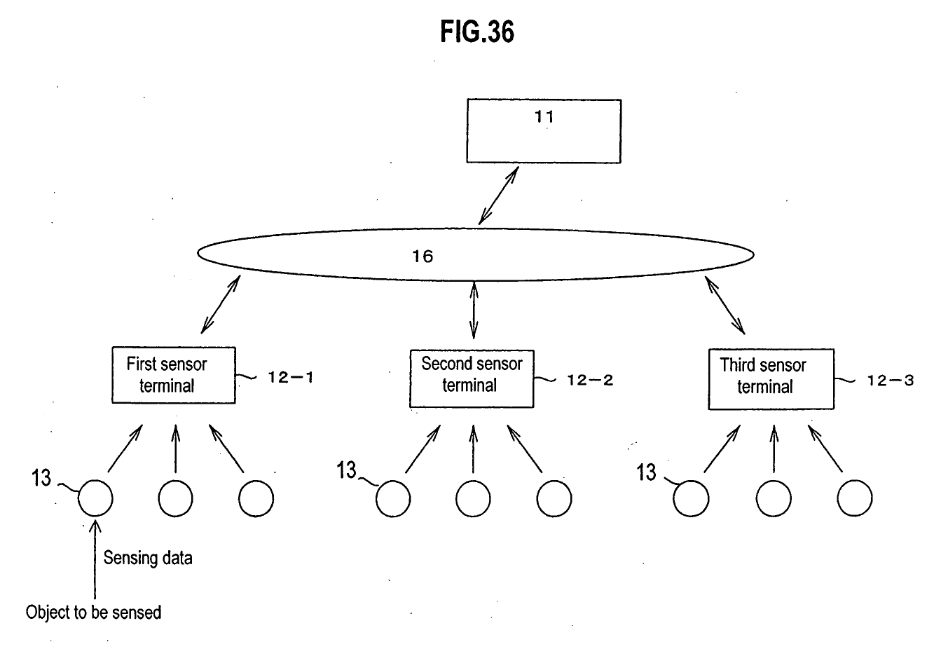

FIG. 37 is a figure used to explain user discomfort when information on the user's activities is being collected by a conventional information provision system.

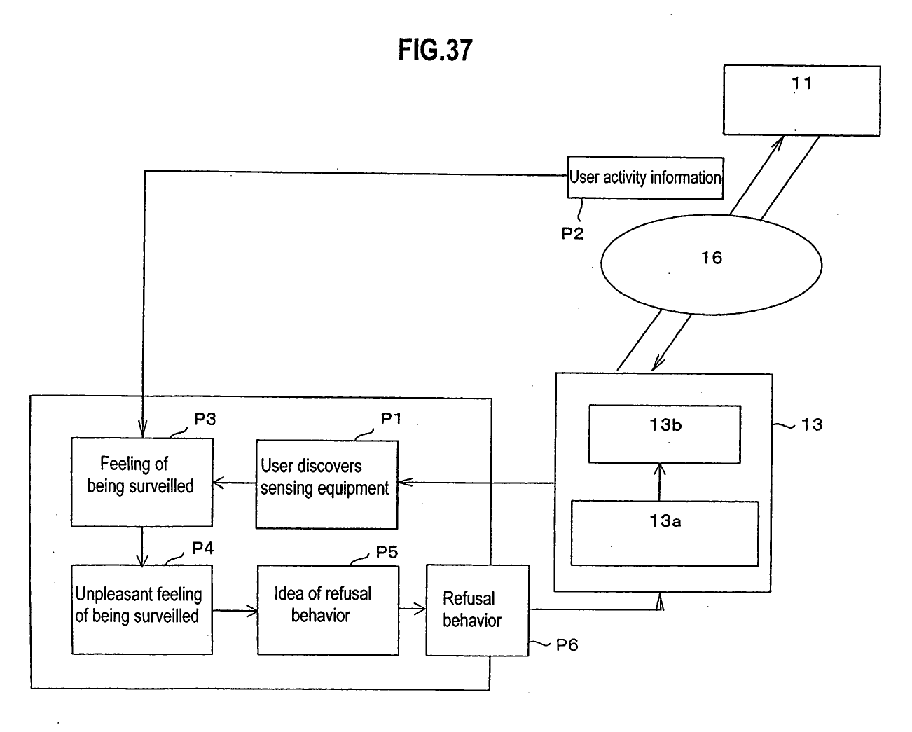

### PREFERRED EMBODIMENTS OF THE INVENTION

Embodiments of the present invention will be described below. In these embodiments, unless otherwise stated, any specific mention of such details as the dimensions, materials, or relative positioning of any of the component parts should not be construed as to limit the scope of this invention; they are merely included for purposes of explanation. Numerical values and the like appearing in the description below do not in any way limit the scope of this invention.

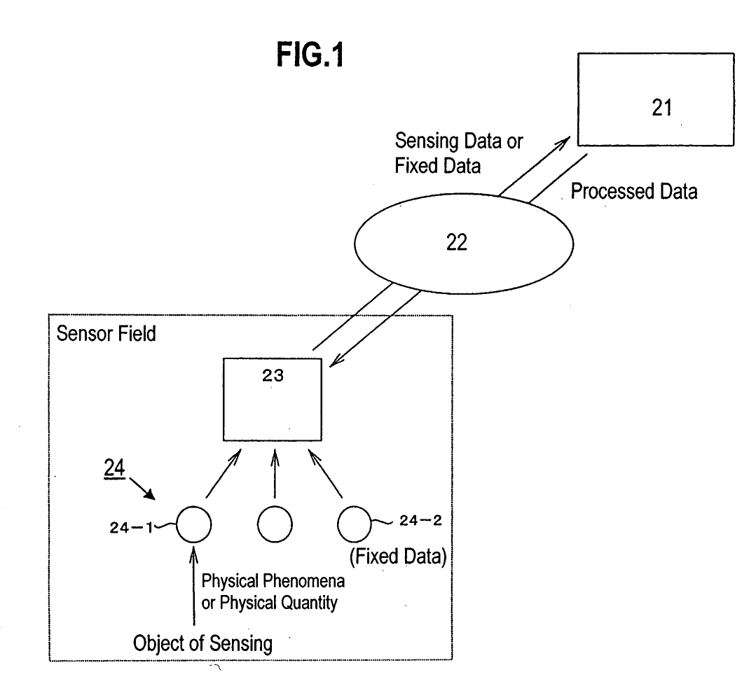

With reference to FIG. 1, in the information provision system shown in the figure, data processing server 21 is connected to network 22 (e.g. the Internet), and network 22 is connected to user terminal device 23. Data transmitters 24 are located at predetermined intervals, and these data transmitters 24 have sensing data transmitters 24-1 that transmit sensing data on the object of the sensing, and fixed data transmitters 24-2 that transmit predetermined data as fixed data (e.g. position information). As will be described below, user terminal device 23 receives this sensing data and/or fixed data and sends it to data processing server 21. Then, data processing server 21 performs the requisite processing upon the sensing data and/or fixed data to produce processed data that is then sent to user terminal device 23.

The object being sensed may provide physical phenomena or physical quantity type data, for example, objects of sensing can be related to empty space such as temperature, humidity, noise, vibration, wind force, brightness, etc. Examples of fixed information would be place names, position (latitude/longitude) and other such fixed information that is installed into transmitter 24-2.

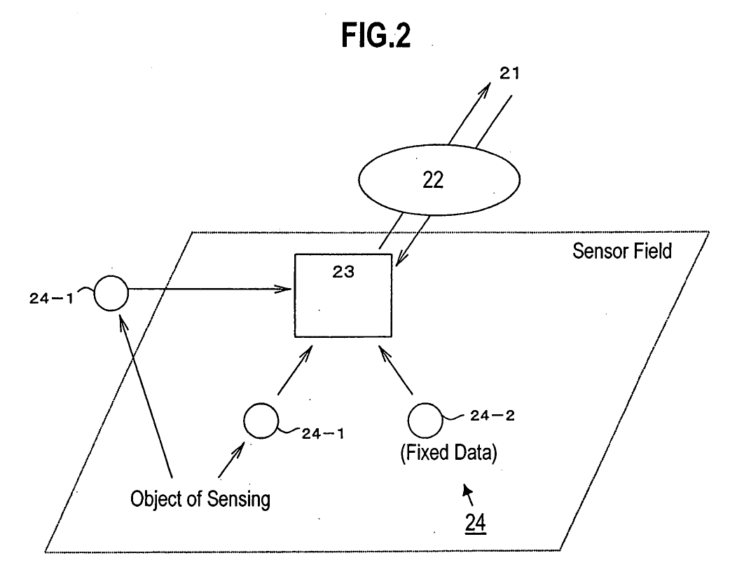

As is shown in FIG. 2, when user terminal device 23 and data transmitter are located in the same space (in a predefined space), user terminal device 23 may receive sensing data and fixed data transmissions from data transmitter 24. Hereinafter, this sort of space will be called a “sensor field.” The sensing data transmitter 24-1 is not necessarily located in the same spatial area as the object of the sensing, and so long as the information acquired from the object of the sensing can be transmitted to user terminal device 23, then it need not be located in the same spatial area.

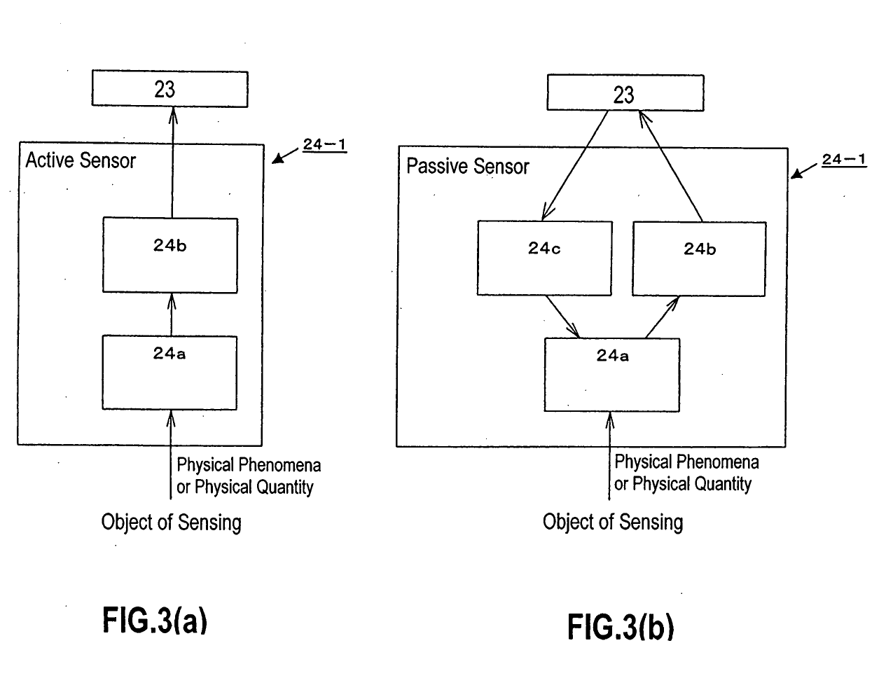

With reference to FIG. 3, the Figure shows a function block diagram that illustrates the functions of sensing data transmitter 24-1. The sensing data transmitter 24-1 is a so-called “sensor” and this sensing data transmitter 24-1 may be equipped with active sensors and passive sensors. As indicated in FIG. 3(a), an active sensor would have the data sensing function 24a and the data transmission function 24b. The data sensing function 24a detects (senses) the object of the sensing and obtains sensing data on its physical phenomena or physical quantities. This sensing data is transmitted by the data transmission function 24b to the user terminal device 23.

On the other hand, as shown in FIG. 3(b), with passive sensors, in addition to data sensing function 24a and data transmission function 24b, a request reception function 24c has been added. When request function 24c receives a sensing information request from user terminal device 23, that request is relayed to the data sensing function 24a. This causes the data sensing function 24a to detect the object of the sensing to obtain a physical phenomena or physical quantity as sensing information, which is sent to user terminal device 23 as sensing data via the data transmission function 24b.

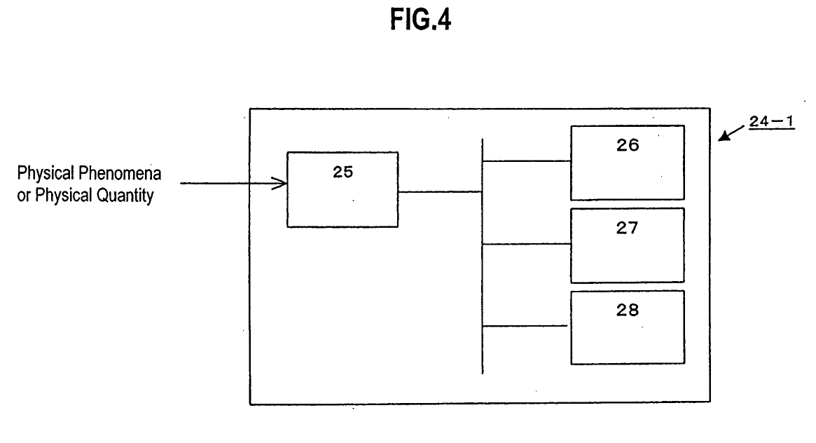

FIG. 4 is a block diagram showing the hardware configuration for the sensing data transmitter 24-1. The sensing data transmitter 24-1 is comprised of sensing unit 25, computer unit 26, memory unit 27, and transmitting unit 28. With regard to passive type sensing data transmitters 24-1, they are further equipped with a receiver unit (not shown). In the example in the figure, sensing unit 25 detects physical phenomena or physical quantities for the object being sensed.

The sensing data, as explained in FIG. 3, is transmitted from transmission unit 28 to user terminal 23. At this time, computer unit 26 is generating sensing data by processing the detected physical phenomena or physical quantities. Memory unit 27a holds a control program, etc., and also provides temporary storage for the data.

Further, with regard to a passive sensing data transmitter 24- 1, based upon the sensing data request received by the its computer unit 26, sensing unit 25 acquires physical phenomena data or physical quantity data to generate sensing data, which is then transmitted from transmitting unit 28 to the user terminal 23.

Also, the sensing data transmitter 24-1 can be equipped with a plurality sensing units 25, and a computer unit 26 and memory unit 27 may be added if needed. Thus, in the simplest example, physical phenomena or physical quantities detected by sensing unit 25 are sent to the user terminal device 23 from transmitter unit 28.

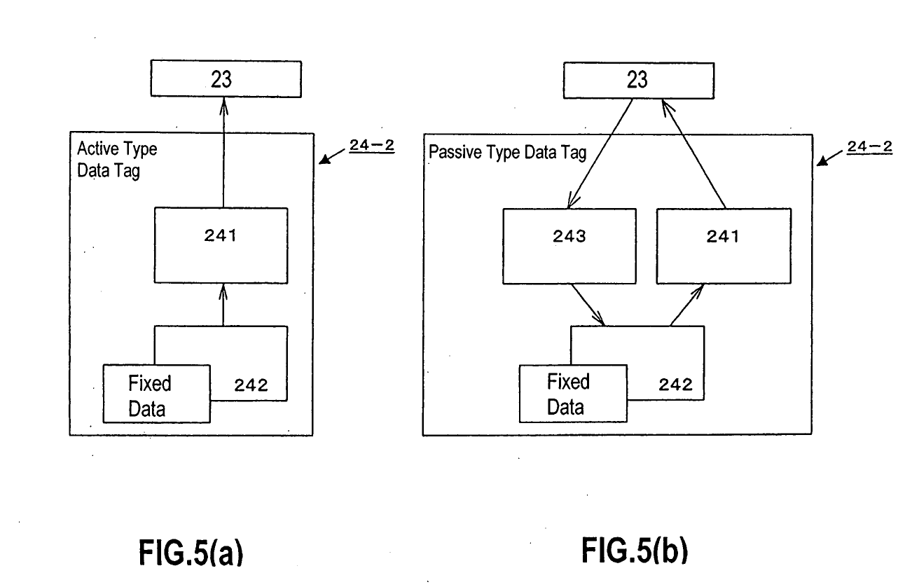

FIG. 5 shows a functional block diagram for the fixed data transmitter 24-2; the fixed data transmitter 24-2 may be either an active type or a passive type. As is shown in FIG. 5(a), the active type fixed data transmitter 24-2 is equipped with a data transmitting function 241 and data retention function 242. The data retention function 242 holds the fixed data.

Data retention function 242 is constantly holding fixed data which is passed to data transmitting function 241. Active type fixed data transmitter 24-2 functions as active type data tags. What is meant by “fixed information,” is, for example, place name information, address information, name information (such as train station name, building name, platform number in the train station, building floor number, room number, etc.)

On the other hand, as shown in FIG. 5(b) for the passive type fixed data transmitter 24-2, in addition to its having data transmitting function 241 and data retention function 242, it has a request reception function 243. When a fixed data request is received from user terminal device 23 by the request reception function 243, that request is relayed to data retention function 242. This causes the fixed data being stored by the data retention function 242 to be sent to the data transmission function. Thus, passive type fixed data transmitter 24-2 functions as a passive tag.

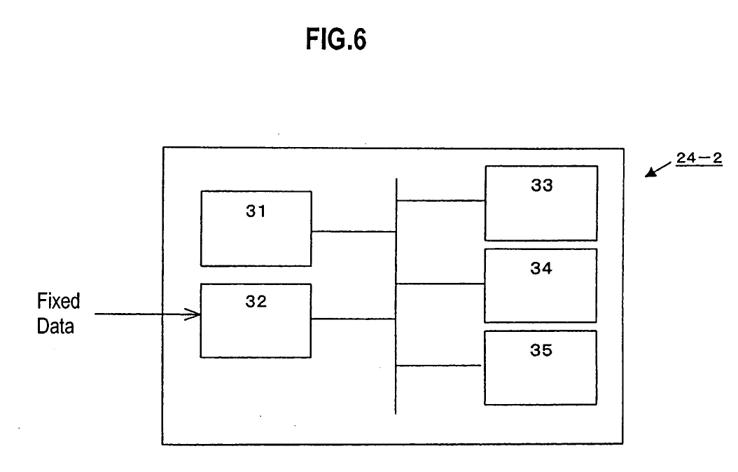

FIG. 6 is a block diagram of the hardware configuration for fixed data transmitter 24-2. The fixed data transmitter 24-2 is comprised of fixed data memory unit 31, fixed data read/write (R/W) unit 32, computer unit 33, memory unit 34, and transmitter unit 35. In a passive type fixed data transmitter 24-2, there is an addition receiver unit (not shown). In the example in the figure, fixed data is stored in fixed data memory unit 31.

This fixed data is written into fixed data memory unit 31 by fixed data R/W unit 32, and the fixed data that has been written to fixed data memory unit 31 is also read from fixed data memory unit 31 by fixed data R/W unit 32. The fixed data is written to fixed data memory unit 31 in advance by fixed data R/W unit.

Fixed data that has been read from fixed data memory unit 31 undergoes processing in computer unit 33 (for example, converted into transmission data) and then, to explain with reference to FIG. 5, it is sent from transmitter unit 35 to user terminal device 23. A control program or the like is stored in memory unit 34 along with the data. Further, in a passive type of fixed data transmitting unit 24-2, fixed data R/W 32 is controlled by the computer unit 33 based upon the receipt of fixed data requests by the receiver unit, and the appropriate fixed data is then read from fixed data memory unit 31.

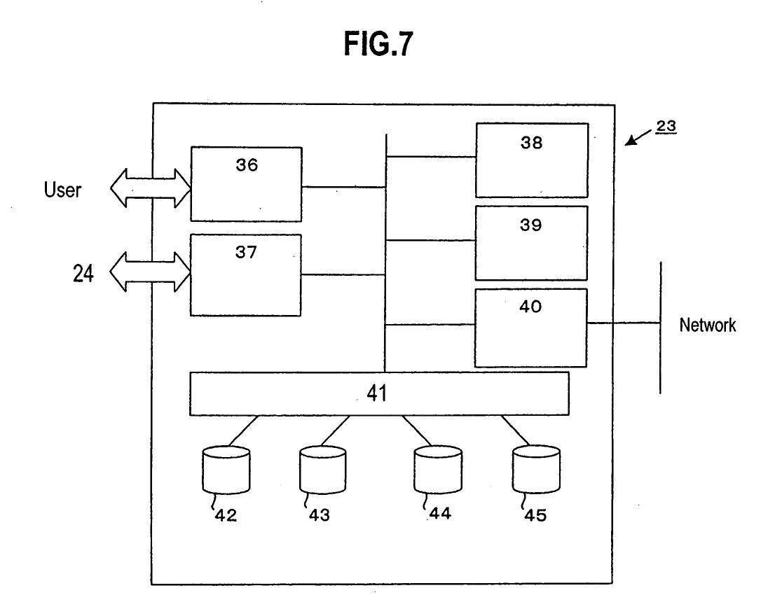

Next, the hardware configuration for user terminal device 23 will be explained with reference to FIG. 7.

User terminal device 23 is used by the user, and it is equipped with, for example MM (man-machine) input/output unit 36, sensing equipment communications unit 37, computer unit 38, memory unit 39, network communications unit 40, and database (DB) management unit 41. DB management unit 41 manages process program unit 42, sensing data DB 43, processed data DB 44, and program data unit 45.

As previously described for FIGS. 1 and 2, user terminal device 23 sends and receives data via network 22 to and from data processing server 21 (it sends sensing data and fixed data and receives processed data), and in addition, it presents various types of information to the user. MM input/output unit 36, comprised of an input unit and output unit, functions as the interface with the user. Examples of input units include a keyboard, ten numerical keys, mouse, microphone, barcode reader, etc.

The output unit would have, for example, a display, printer, speaker, etc. Computer unit 38 would be driven by and carry out processing directed by the various functions of user terminal device 23; it is comprised of, for example, a central processing unit (CPU). Memory unit 39 provides the memory area for computer unit 38 to execute programs, and it may be comprised of ROM and RAM. Network communications unit 40 enables connections to the outside via a network 22 (for example, with data processing server 21) by controlling the communications. Sensing equipment communications unit 37, as described above, receives sensing data from the aforementioned sensing data transmitter 24-1 and fixed data transmitter 24-2, and in addition, it transmits processing requests in the case that sensing data transmitter 24-1 and fixed data transmitter 24-2 are of the passive type.

The process program unit 42 includes the programs to provide the information presentation function to the user, to acquire sensing data and fixed data, and to transmit to data processing server 21. The operating system (OS) is also included within process program unit 42. Also, as will be described below, a program to perform downloads from data processing server 21 has also been written into process program unit 42. Sensing data DB 43 allows for the temporary extraction of sensing data and fixed data that was obtained from sensing data transmitter 24-1 and fixed data transmitter 24-2 in order that the sensing data and fixed data undergo processing in computer unit 38.

Processing data DB 44 holds processing data obtained from data processing server 21. In addition to the above described functions, program data unit 45 may store other programs or data in order to realizes its full function. For example, program data unit 45, when the user terminal device 23 is a computer, may include word processing or spreadsheet software, and when user terminal device 23 is a wireless telephone, it may have a program to implement communications functions.

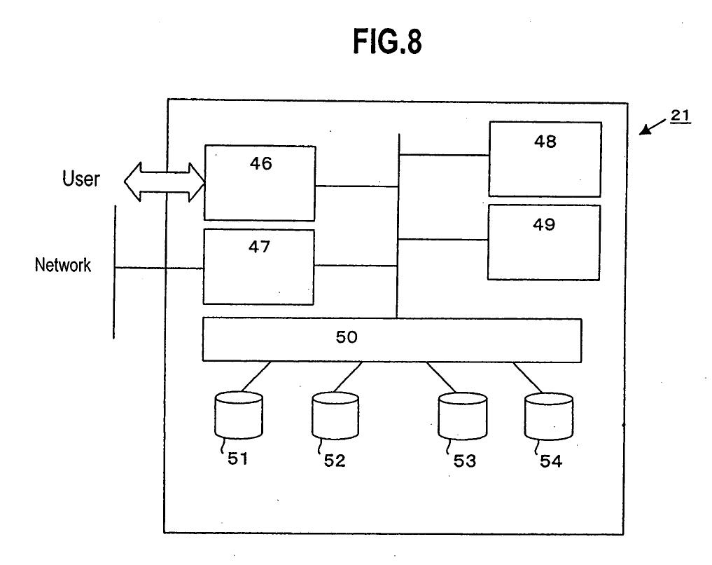

The hardware configuration of data processing server 21 will now be described with reference to FIG. 8.

As described above, data processing server 21 receives sensing data and/or fixed data and sends processed data to user terminal device 23. Data processing server 21 is comprised of, for example, MM (man-machine) input/output unit 46, network communications unit 47, computer unit 48, memory unit 49, and DB management unit 50. DB management unit 50 administers data processing program unit 51, download program DB 52, accumulated services fees DB 53, and program data unit 54.

MM input/output unit 46 functions as the interface with the operator, and it has both input and output units. Examples of input units include a keyboard, numerical key pad, mouse, microphone, barcode reader, etc. Examples of output units include a display, printer, speaker, etc. Computer unit 48 provides computing functions to drive the various functions of data processing server 21 and to perform processing; it consists, for example, of a CPU. Memory unit 49 provides a memory area for computer unit 48 to execute programs, which consists, for example of ROM and RAM. Network communications unit 47 controls communications via network 22 with user terminal device 23.

Programs that perform the desired processing upon the sensing data and fixed data are stored in data processing program unit 51, which also holds the OS. Download program DB 52 contains programs to utilize the processed data from data processing server 21, and these programs can be downloaded in response to requests issued via user terminal device 23.

Accumulated service fees DB 53 contains in its memory the accumulated cost for each user terminal that were generated in response to processing performed by data processing server 21. Program data unit 54 stores programs and other data that is necessary to implement functions other than those described above. It may have, for example, word processing software fore use by the server operator.

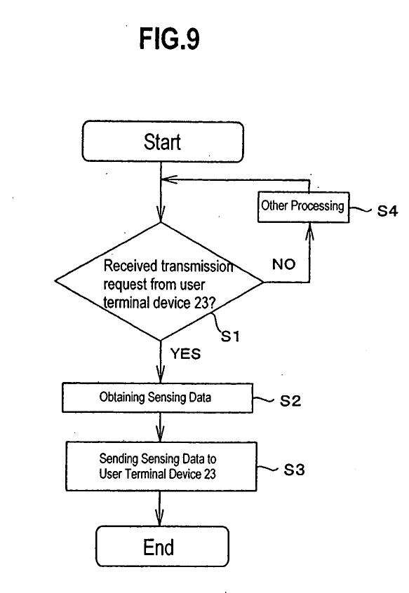

At this point, the operation of an information provision system according to the present invention will be described with reference to FIG. 1, and FIG. 9 through FIG. 16.

Here, if we specify that sensing data transmitter 24-1 is a passive type of sensing data transmitter, as is shown in FIG. 9, computer unit 26 (FIG. 4) oversees whether or not an information request (transmission request) has been received via the receiver unit from user terminal device 23 (step S1). If a transmission request has been received, then physical phenomena or quantity data is obtained from sensing unit 25 (FIG. 4) (step S2). Then, computer unit 26 sends the physical situation or quantity type sensing data to user terminal device 23 via transmitter 28 (FIG. 4) (step S3). On the other hand, if no transmission request has been received, computer unit 26 performs other processing (step S4), and returns to step S1.

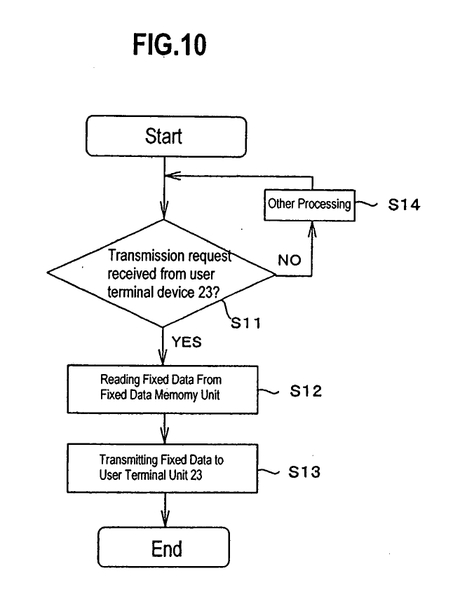

Also, as is shown in FIG. 10, at fixed data transmitter 24-2 (assuming that fixed data transmitter 24-2 is of the passive type) computer unit 33 (FIG. 6) oversees as to whether or not an information request (transmission request) has been received from user terminal device 23 via the receiver unit (step S11); if a transmission request has been received, the fixed data R/W unit (FIG. 6) is controlled to cause the appropriate fixed data to be read from fixed data memory unit 31 (step S12). Then, computer unit 33 transmits this fixed data to user terminal device 23 via its transmitter unit 35 (FIG. 6) (step S13). On the other hand, if no transmission request has been received, computer unit 33 performs other processing (step S14), and returns to step S11.

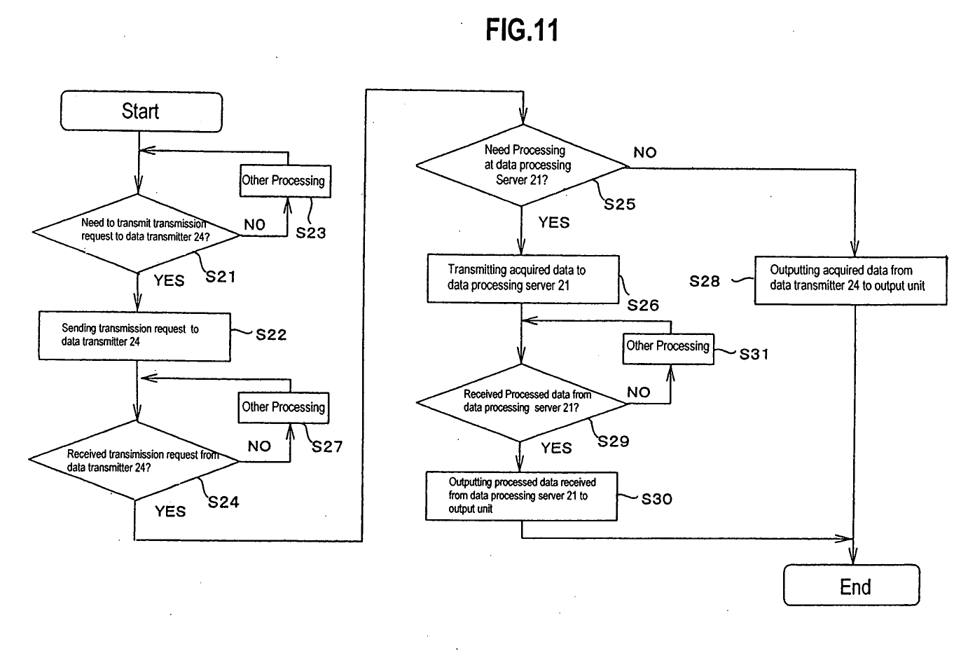

Referring to FIG. 11, when the user operates user terminal device 23, computer unit 38 (FIG. 7) determines whether or not a data transmission request has been made to data transmitter 24. To wit, it determines whether it is necessary to send a transmission request to data transmitter 24 (step S21). Computer unit 38 transmits a transmission request to data transmitter 24 via sensing equipment communications unit 37 (FIG. 7) (step S22).

Thus, in a manner similar to that explained for FIGS. 9 and 10, sensing data and fixed data is sent from data transmitter 24 to user terminal device 23. If no transmission request is required, computer unit 38 may perform other processing (step S23), and then return to step S21.

Computer unit 38 oversees whether or not data has been received from the data transmitter 24 (step S24), if data (acquired data) has been received from data transmitter 24 computer unit 38 makes the further determination of whether processing is required (step S25). To wit, it determines whether processing is required at the data processing server 21. If it determines processing is required, computer unit 38 controls network communications unit 40 (FIG. 7) to send the acquired data via network 22 to data processing server 21 (step S26).

As will be described later, data processing server 21 processes the acquired data (sensing data and/or fixed data) to generate processed data. Then, data processing server 21 sends the processed data to user terminal device 23. However, when no data is received from data transmitter 24, the computer may engage in other processing (step S27) before returning to step S24.

On the other hand, in step S25, when the determination is made that processing is not required, computer unit 38 outputs the acquired information to MM input/output unit 36 (step S28), and processing is completed.

Computer unit 38 oversees whether processed information has been received from data processing server 21 (step S29), if processed information has been received from data processing server 21, computer unit 33 outputs the processed information to MM input/output 36 (step S30), and processing is completed. However, if no processed information is received from data processing server 21, it is free to perform other processing (step S31) before returning to step S29.

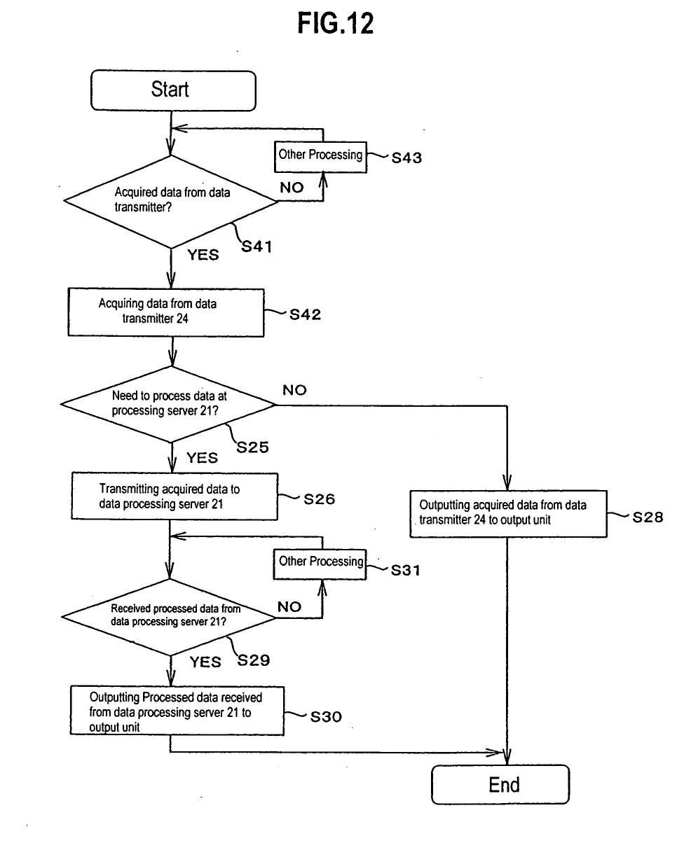

FIG. 11 was used to describe the case where the processing corresponding to that explained for FIGS. 9 and 10 is performed in the user terminal device (to wit, when data transmitter 24 is of the passive type), but when data transmitter 24 is of the active type, processing is performed as shown in FIG. 12. In FIG. 12, processing steps that correspond to those described for FIG. 11 bear the same reference numbers, and further explanation of them will be omitted.

With an active type data transmitter 24, sensing data or fixed data is constantly being sent out, so computer unit 38 oversees whether data has been obtained from the active data transmitter via sensing equipment communications unit 37 (FIG. 7) (step S41). When there is data input from active type data transmitter 24, computer unit 38 acquires that data (step S42). However, if there is no data input from active data transmitter 24, it may engage in other processing (step S43), before returning again to step S41. When computer unit 38 acquires data from the active type data transmitter 24, a procedure similar to that described for FIG. 11 is followed from step S25.

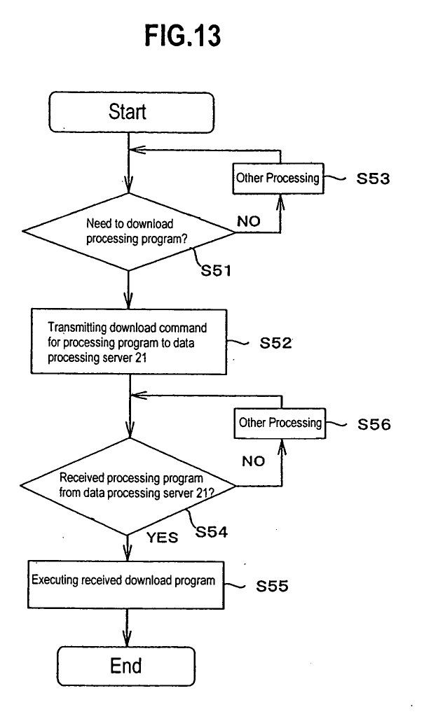

Next the program download operation by user terminal device 23 from data processing server 21 will be described with reference to FIG. 13.

When computer unit 38 is engaged in the processing shown in FIG. 6 and a determination is made that a processing program must be downloaded (step S51), it issues a download request for a processing program to data processing server 21 via network communications unit 40 (FIG. 7) (step S52). As will be further elaborated, data processing server 21 responds to the download request and downloads the appropriate processing program to user terminal device 23.

If there is no need for the download of a processing program, computer unit 38 may engage in other processing (step S53) before returning to step S51.

After the issuance of the download request, computer unit oversees whether or not the processing program has been downloaded from data processing server 21 (step S54), and if the processing program has been downloaded from data processing server 21, it executes that processing program (step S55). When not downloading a processing program, computer unit 38 may engage in other processing (step S56) before returning to step S54.

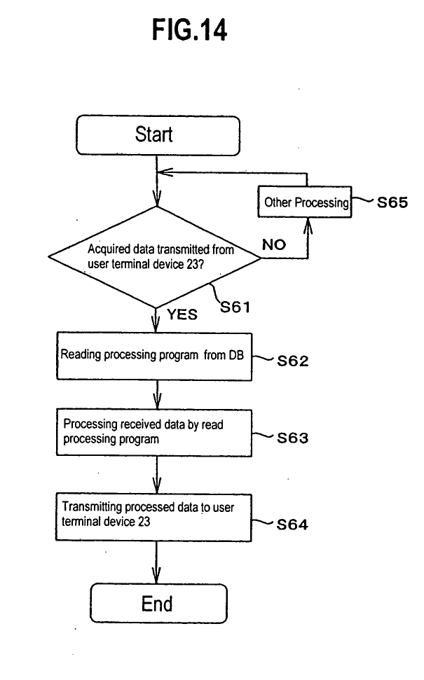

With reference to FIGS. 8 and 14, computer unit 48 of data processing server 21 oversees whether acquired data (sensing data and/or fixed data) has been transmitted from user terminal device 23 (step S61). In other words, computer unit 48 oversees whether sensing data and/or fixed data has been received. When sensing data and/or fixed data have been received, computer unit 48 controls DB management unit 50 to read in from the data processing program unit 51, the appropriate program for processing said sensing data and/or fixed data (step S62).

Then, based upon the processing program, computer unit 48 processes the sensing data and/or fixed data to generate processed data (step S63). After that, computer unit 48 controls network communications unit 47 to transmit the processed data to user terminal device 23 (step S64), and processing is then completed.

However, if no sensing data and/or fixed data is received, computer unit 48 may perform other processing (step S65) before returning to step S61.

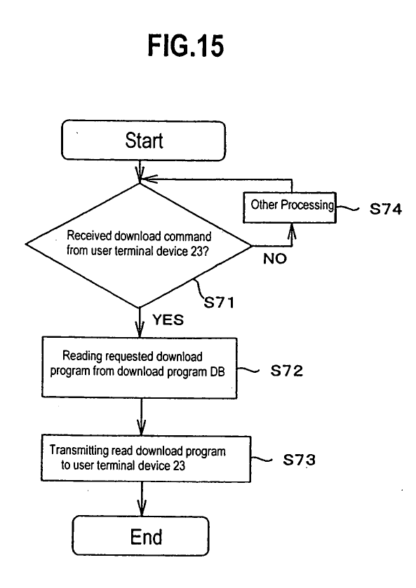

As shown in FIG. 15, when a download request is issued from user terminal device 23 (step S71), computer unit 48 controls DB management unit 50, to cause the designated processing program to read in from download program DB 52 (step S72). Then, computer unit 48 controls network communications unit 47 to transmit this download program to user terminal device 23 (step S73), and then processing is completed.

If there is no download request, computer unit 48 may engage in other processing (step S74), before returning to step S71, where it oversees whether a download request has been issued.

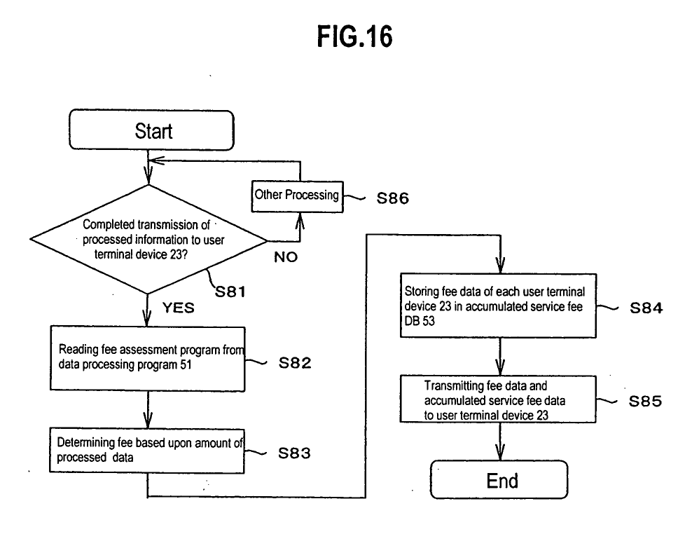

Next, the fee assessment processing in data processing server 21 will be explained with reference to FIGS. 8 and 16.

When transmission of processed information to user terminal device 23 has been completed (step S81), computer unit 48 controls DB management unit 50 to cause the fee assessment program to be read in from data processing program unit 51 (step S82). Then, computer unit 48, based upon this fee assessment program, determines the correct fee based upon the amount of processed information delivered (step S83). Then, computer unit 48 controls DB management unit 50 to allot that fee to the corresponding user terminal device 26, and accumulated service fee DB 53 stores the accumulated fee (step S84). To wit, accumulated service fee DB 53 stores in memory the accumulated. amount of the fees for each user terminal device.

After accumulated service fee DB 53 has stored the service fee, computer unit 48 controls network communications unit 47 and causes the fee for the current session and the accumulated fee to be transmitted to user terminal device 23 (step S85). This enables the user to find out from user terminal device 23 the fee for the data processing and the accumulated fees.

Also, so long as the transmission of processed information has not been completed, computer unit 48 is free to perform other processing (step S86), and then return to step S81 and wait until the transmission of the processed information has finished.

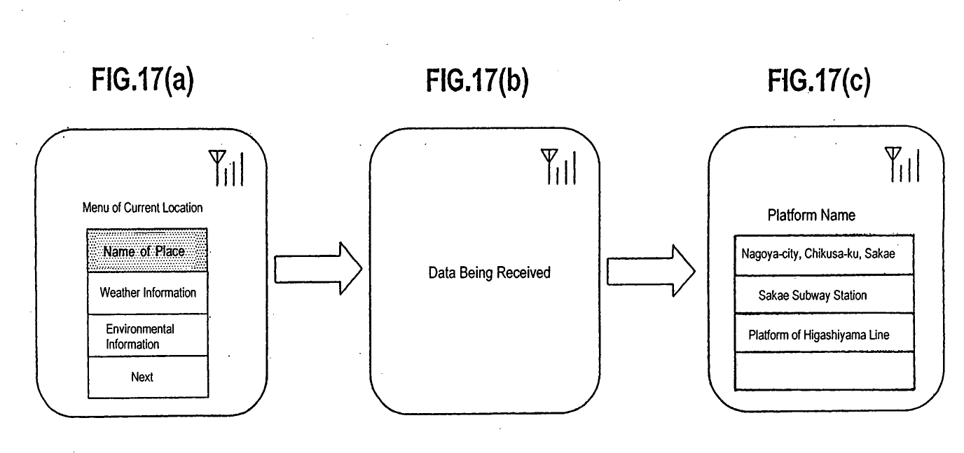

Here, as an example, the screen display on a wireless telephone employed as the user terminal device will be described. As explained for FIG. 7, with regard to the screen (display) of MM input/output unit 36, as shown in FIG. 17, the initial screen is a display of an information menu about the current location. In the example in the figure, the current position information includes a display of columns for selection of the name of the place, weather information and environmental information; selecting “Next” brings up a display of other information items.

If the place name selection is made, as explained for FIGS. 9 and 10, fixed data transmitter 24-2 sends place name information to the wireless telephone. Until that place name is received by the wireless phone, the display shows “data being received” as shown in FIG. 17b. FIG. 17(c) shows the example of acquiring information on the platform name in a subway station, where as place name information, the display reads “Nagoya City, Chigusa-ku Sakae, Sakae Subway Station, platform of the Higashiyama line.”

As described above, when place name information is obtained for a subway, etc., it is necessary for fixed data transmitter 24-2 to acquire the fixed data, but above ground, equipping the wireless telephone with a GPS receiver enables position information to be obtained from the electric transmissions (GPS signals) from the GPS satellites. In this case, the GPS satellites would correspond to a fixed data transmitter 24-2, but in order for the wireless telephone to obtain place name information from the GPS satellite transmissions, it must be able to perform the conversion processing to convert latitude and longitude data into place name information.

In the example depicted in FIG. 17, a wireless telephone was used as user terminal device 23, but user terminal device 23 is not confined to wireless telephones, it could also be a notebook computer, PDA or wrist watch based terminal.

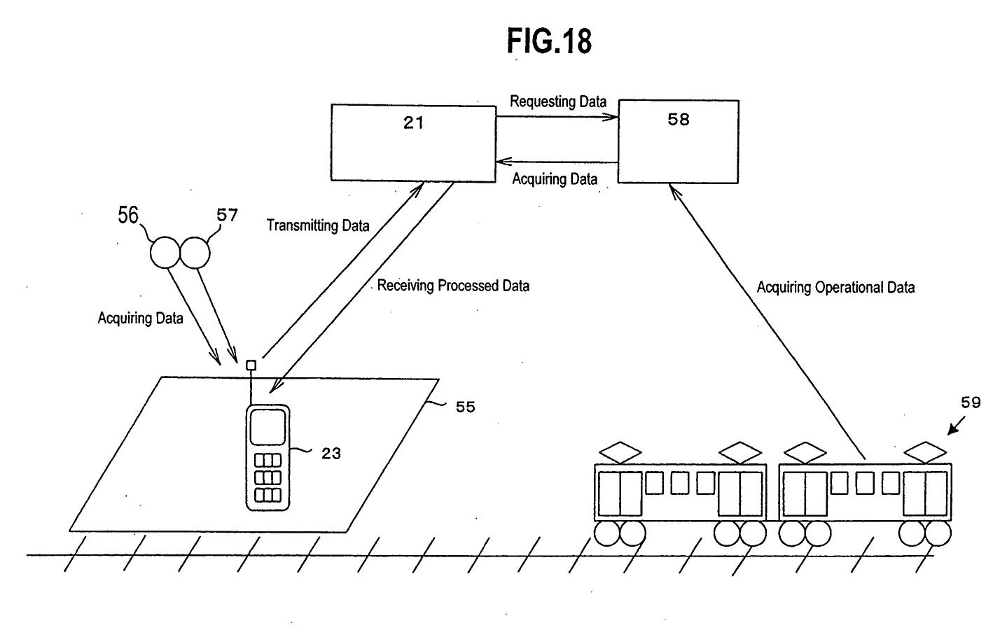

At this point, explanation will be made with reference to FIG. 18 of acquiring commuter train operational information using a wireless telephone as user terminal device 23 while on the platform of a train station (here, the reference number for the wireless telephone is 23).

When a user wants information about train arrivals using wireless telephone 23 while standing on station platform 55, he inputs the startup operation for wireless phone 23 (i.e. selects the schedule of train arrivals from the menu displayed on its screen), which causes the data transmitters located in the sensor field, including platform 55, to transmit sensing data and fixed data from their data transmitters to wireless telephone 23 (In FIG. 18, the data transmitters are of the passive type, and in the Figure, the fixed data transmitter is referred to as sensor 57 for the position information tag 56.)

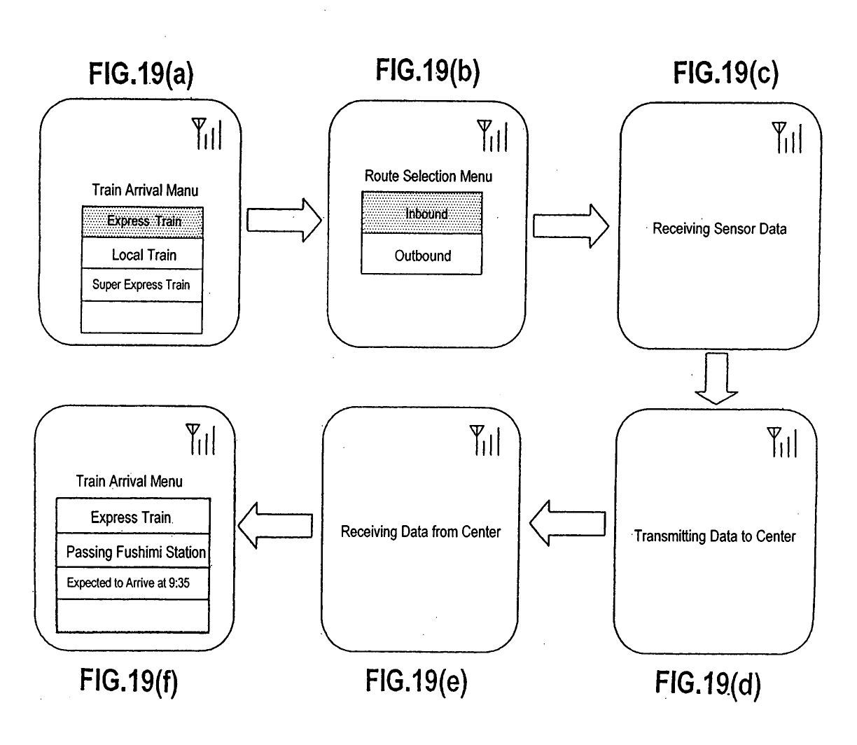

When wanting to find out the train's arrival time, the train arrival time request is input, which causes it to be sent to the data transmitter (which, in this case, is position data tag 56). In response to this, wireless telephone 23 displays the train arrival schedule menu shown in FIG. 19(a). Now if the user selects “express train,” the next menu is displayed for route selection for commuting inbound to or outbound from the city.

Here, when the user selects the route going inbound, the current location information (position data) is sent from position data tag 56 to wireless telephone 23 (while receiving the position data, wireless telephone 23 displays the “receiving sensor data” message on its screen). When the reception of the position data is complete, as described previously, the position data along with the request for the express train into the city is transmitted to the data processing server (Center) (the network is not shown in FIG. 18). At this time, as shown in FIG. 19(d), the message on wireless telephone 23's display reads “transmitting data to the Center.”

Here, operations system 58 is managing commuter train operations, and operational data from each train 59 is sent to train operating system 58. In other words, each train transmits operational data such as its location and speed to the train operations system 58. Based upon this operational data, the display on train operations system 58 shows the type of each train, the direction it is running, its position, etc.

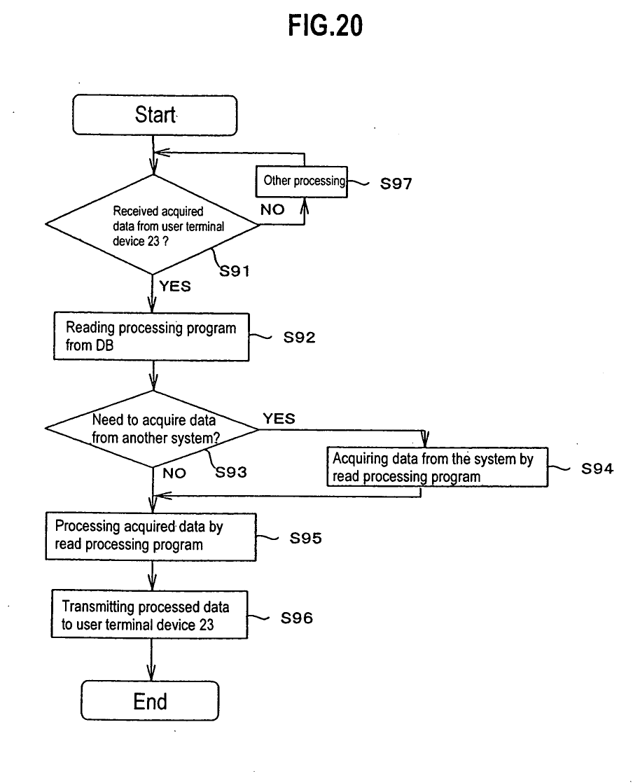

Now, with reference to FIG. 20, data processing server 21 (Center) oversees whether or not acquired information (sensing data and/or fixed data) has been received from a user terminal device (wireless phone) 23 (step S91), and if acquired information is received (here it is position data, train speed and direction data), as described above, computer unit 48 (FIG. 8) reads the appropriate processing program from the data processing program unit 51 (FIG. 8) (step S92).

Then, data processing server 21 (that is, computer unit 48) determines whether there is a need to acquire data from another system (step S93). Since in this case, information about the arrival time of an (inbound) express train is needed, the determination is made that data must be acquired from another system (here it is train operations system 58), and data processing server 21 issues a data acquisition request to train operations system 58. Making the data acquisition request, requests the acquisition of data related to the (inbound) express train.

Train operations system 58 responds to the data acquisition request, and transmits train data to data processing server 21. In the example depicted in the figure, since the data acquisition request related to the (inbound) express train, train operations system 58 transmitted data related to the (inbound) express trains to data processing server 21. In other words, data processing server 21 acquires data about the (inbound) express trains (step S94).

Next, data processing server 21, based upon the current location data received from wireless telephone 23 and the time, searches data on the (inbound) express trains to determine the location (i.e. train station) of the express train closest to the current location. In other words, data processing server 21 processes the data on the (inbound) express trains to obtain processed data (step S95). As a result of its search processing, information is transmitted to wireless telephone 23 by data processing server 21 that is related to the closest station that the express train has passed (including the expected arrival time at the user's station) as the expected arrival time for the train (step S96).

In step S91, if the acquisition data is not received from user terminal device 23, data processing server 21 engages in other processing (step S97), and then returns to step S91; or, if in step S93, if a determination is made that it is not necessary to obtain data from another system, data processing server 21 performs step S95.

As described above, acquired data is transmitted to data processing server 21 by wireless telephone 23, and when the train's expected arrival time data is received from data processing server 21, first, as shown in FIG. 19e), a message “receiving data from the Center” is displayed on the screen of wireless telephone 23. Then, after completion of the reception, a message such as shown in FIG. 19(f) is displayed on the screen of wireless telephone 23 that indicates the train's scheduled arrival time, that it is an express train, that it has passed location XX, and that it is expected to arrive at 9:35.

This makes it possible for a user to easily obtain train operating schedules (train arrival times) while standing on platform 55 in a train station.

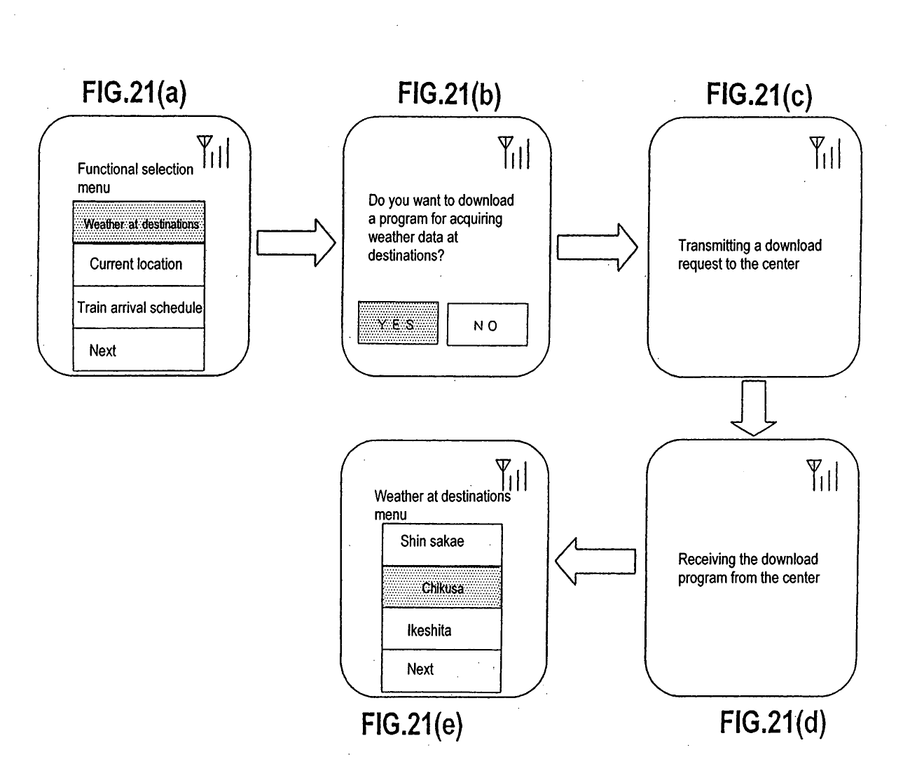

Next, with reference to FIGS. 21 through 23, an example of obtaining weather information for one's destination from platform 55 in a train station will be described.

First a selection is made from the function menu displayed on the screen of wireless telephone 23 to acquire information about the weather at the destination (that is, start up input is performed. FIG. 21(a)). When acquiring weather data about the destination, it is necessary to download from the Center (data processing server 21) a destination weather data acquisition program (if wireless telephone 23 does not already have the destination weather data acquisition function). Thus, when the selection is made to get the weather information for the destination at the wireless telephone 23, the screen displays a message asking whether or not to download the destination weather data acquisition program (FIG. 21(b)).

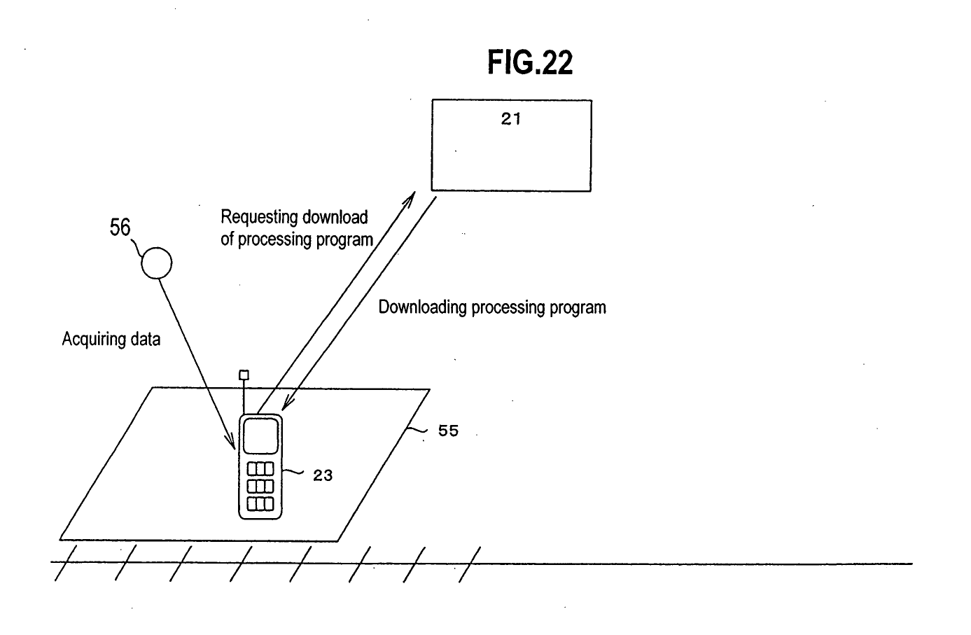

When the user selects “Yes,” wireless telephone 23 displays “transmitting download request to the Center, (FIG. 21(c)), and the download request is transmitted to the Center (See FIG. 22, at this time, wireless telephone 23 transmits to the Center the position data obtained from position data tag 56).

The Center, that is, data processing server 21, as described for FIG. 15, references the position data from wireless telephone 23, and searches from among its processing programs, for the destination weather data acquisition program, and then transmits that program to wireless telephone 23 (see FIG. 22). At this time, wireless telephone 23 displays the message “receiving program from the Center” (FIG. 21(d)).

When wireless telephone 23 has completed its reception of the destination weather data acquisition program, said program is executed. Executing the destination weather data acquisition program causes the destination weather data acquisition program menu to be displayed on wireless telephone 23 (FIG. 21(e)).

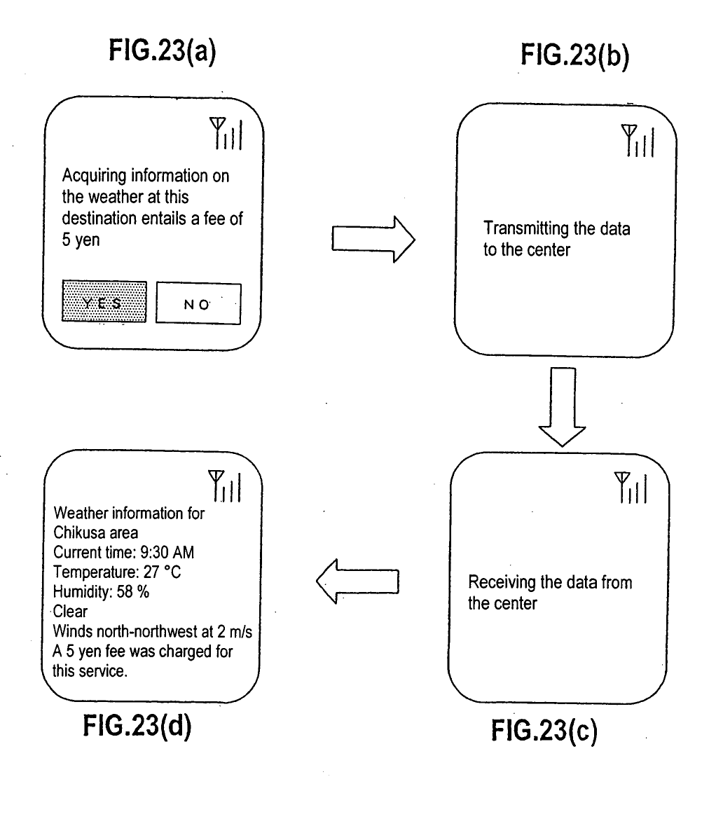

Now, when the user selects “Chikusa” from the destination weather data menu, if the acquisition of such destination weather information is a fee-based service, the screen of wireless telephone 23, where the destination weather data acquisition program is running, displays a warning message that a service fee is required (FIG. 23(a)), such as: “Acquiring information on the weather at this destination entails a fee of 5 yen”. At this point, if the user selects “Yes,” wireless telephone 23, that is, the destination weather data acquisition program, sends a request to the Center to obtain weather data for Chikusa-ku. At this time, a message is displayed on the screen of wireless telephone 23, “transmitting data to the Center” (FIG. 23(b)).

Data processing server 21 then, based upon the request for weather data and as was explained for FIG. 20, obtains the appropriate weather data and transmits it as processed data to wireless telephone 23. At this time, the message displayed on wireless telephone 23 is: “receiving data from the Center” (FIG. 23(c)). To wit, data processing server 23 makes the determination of whether or not it is necessary to retrieve the data from another system (which in this case would be a weather data communications server, etc.), and if it is necessary, it then acquires the weather data from the other system.

In providing this weather data, as explained with regard to FIG. 16, data processing server 21 undertakes fee processing.

After the completion of receipt of the weather data, wireless telephone 23, to wit, the destination weather data acquisition program therein, causes the weather information for the Chikusa station area and surrounds to be displayed on the screen (FIG. 23(d)). For example, as shown in FIG. 23(d), weather information for the Chikusa area might be displayed as: “Current time: (9:30 AM), temperature: (27° C.), humidity: (58%), Clear, winds north-northwest at 2 m/s” along with a display of the fee, “A 5 yen fee was charged for this service.”As described above, a user can easily obtain weather information for this destination. At that time, since it is only necessary for the processing program to be downloaded at the user's request from data processing server 21, very little load is imposed upon data processing server 21.

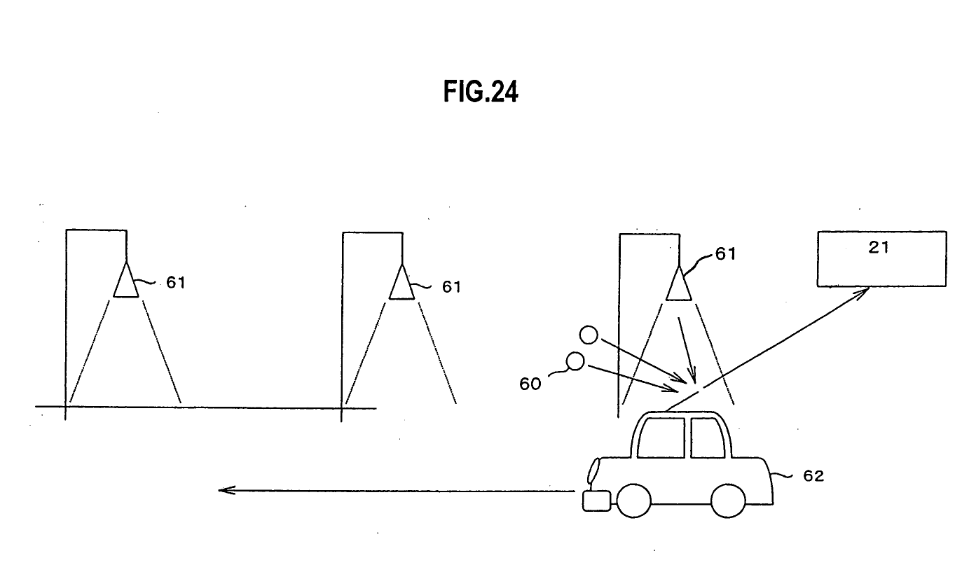

Next, an example of the user terminal device being an automobile will be described with reference to FIG. 24.

Here, we will assume that the above-described sensing data transmitters and fixed data transmitters have been installed along the roadway. In the example shown in FIG. 24, the sensing data transmitters are referred to as ambient environment sensors 60, which are capable, for example, of transmitting data on rain volume, wind velocity, temperature, humidity, etc. On the other hand, position information tag 61 transmits information on the position where it is installed.

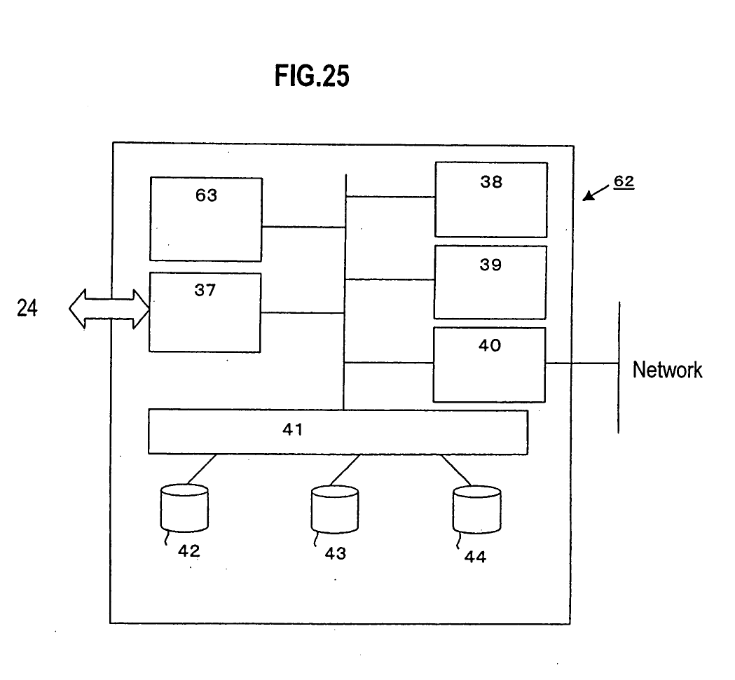

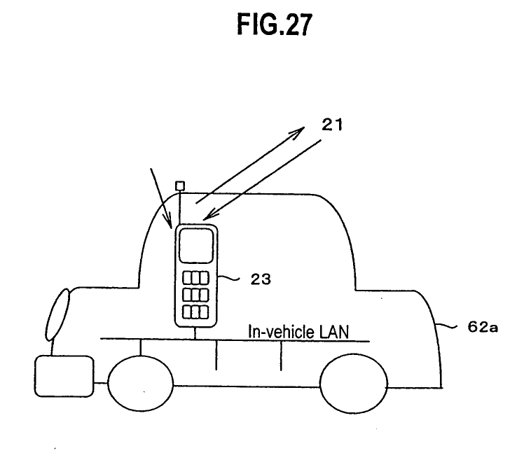

Vehicle (mobile apparatus) 62 includes the hardware configuration shown in FIG. 25. Here, the same component elements that were described for the user terminal device described with reference to FIG. 7 will be given identical reference numbers. Further, mobile unit 62 is equipped with a specialized device/equipment function unit 63 with functions that will be described below. Although it is not shown in FIG. 27, it may be further equipped with MM input/output unit 36.

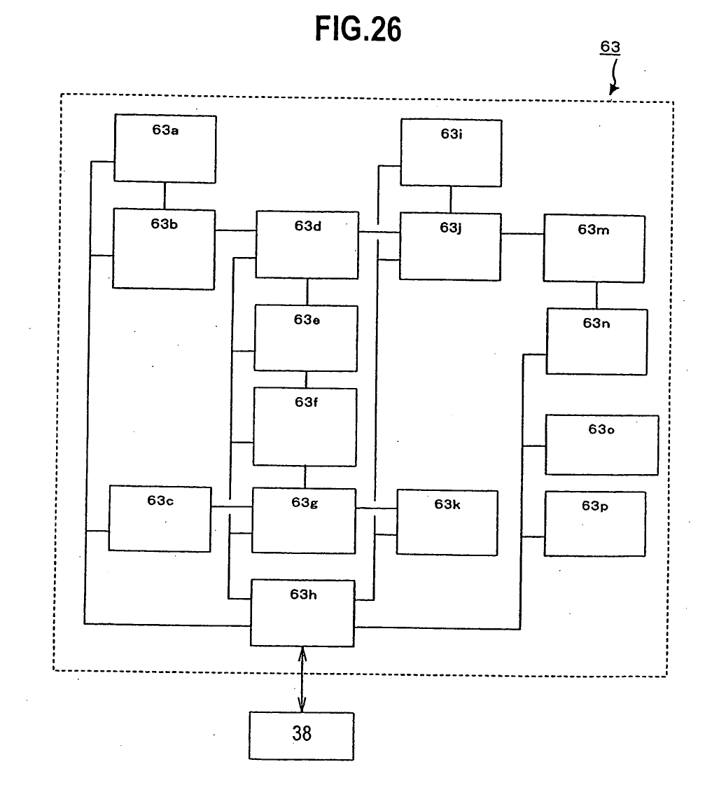

Referring to FIG. 26, specialized device/equipment function unit 63 is equipped with the usual devices and equipment carried on vehicle 62, for example, the specialized device/equipment function unit 63 includes a startup unit (start key) 63a, starter unit (starter motor, spark plugs) 63b, braking unit (brakes) 63c, drive unit (engine) 63d, shaft engagement unit (clutch) 63e, speed changing unit (transmission) 63f, drive wheels (tires) 63g, control unit (controller) 63h, acceleration unit (accelerator) 63i, fuel supply unit (fuel tank) 63j, directional steering unit (handle) 63k, fuel container (fuel tank) 63m, fuel remainder detector (liquid surface sensor) 63n, vehicle position detector (sensor) 63o, and electronic equipment operating unit 63p. Control unit 63h controls other devices/equipment. Control unit 63h is also connected with computer unit 38 (FIG. 25).

As shown in FIG. 26, control unit 63h is equipped with a computer unit (CPU) and a memory unit; control unit 63h can detect the state of other devices and equipment and control those devices and equipment. It is also equipped with a user interface to respond to any need to control other devices or equipment. To wit, the user (driver) uses the interface, the steering wheel of the steering unit, the accelerator of the acceleration unit, and the brakes of the braking unit, and uses the starter key of the starter unit.

Fuel remainder detector 63n detects the amount of fuel remaining inside fuel tank 63m and passes the amount of remaining fuel to control unit 63h. The residual fuel detection unit 63n may be comprised, for example, of a liquid surface sensor. The vehicle position detection unit 63o detects the vehicle's position. For example, the vehicle position detection unit 63o may receive electronic signals from GPS satellites (GPS signals), to determine the vehicle's current position and pass that to control unit 63h. Electronic equipment operations unit 63p functions to operate the electronic equipment carried on the vehicle; examples of such electronic equipment include electronic locks, windshield wipers, headlights, directional signals (turn signals), various lamps (brake lamps, hazard lamps, etc.), speedometer, tachometer (engine RPM counter), audio equipment such as the radio and CD player, the cabin illumination, etc.

Now, with reference to FIGS. 24 through 26, vehicle 62 will obtain ambient environment data and position data as it travels along the road via sensing equipment communications unit 37 of vehicle 62, which acquires the foregoing data from ambient environment sensors 60 and position data tags 61 (in this case, ambient environment sensors 60 and position data tags 61 are of the active type).

Then, as was described for FIG. 7, computer unit 38 transmits the ambient environment data and position data to data processing server 21 via a network (which includes wireless networks). This enables data processing server 21 to collect ambient environment data and position from vehicle 62. In sum, data processing server 21 collects ambient environment data and position data on vehicle 62 just as if it were a measurement terminal device.

Data processing server 21 is informed of and accumulates position data and the respective ambient environmental data (such as rainfall amount, wind speed, temperature and humidity) for each position. This collection of environmental data can be used to respond to request from user terminal devices (not limited to those in vehicles). For example, as explained for FIGS. 21 through 23, if a user terminal device requests acquisition of destination weather information, the above described collection of environmental data can be applied to this task.

On the other hand, control unit 63h is receiving vehicle status information such as vehicle speed, engine RPM, and remaining fuel, and control unit 63h passes this data on the vehicle's operational state to computer unit 38. Then, computer unit 38 transmits the vehicle operating status data from its network communications unit 40 to data processing server 21.

Data processing server 21 can then provide vehicle 62 with a variety of processed information based on the vehicle operating status data. For example, data processing server 21 could be equipped with cartographical data (map data) for areas around the country, or, when it detects that the remaining fuel has dropped to a certain level, it can send the vehicle processed data on the location of the nearest gas station.

Further, should the vehicle's speed exceed some predetermined setting for the location in which it is operating, information server 21 could issue a warning as processed information to vehicle 62. Further, if the engine RPM exceeded a certain predetermined level, data processing server 21 could transmit a warning as processed information to vehicle 62.

In addition, since data on the position of the vehicle is available to data processing server 21, it is possible for information server 21 to know the route the vehicle has traveled based upon the position data. Then, if vehicle 62 provides data processing server 21 with its starting point and destination, data processing server 21 can use all of the information to find the best route, compare it with the route that is being traveled, and issue route corrections to vehicle 62.

As was described above, vehicle 62 can perform just as if it were a measurement terminal device by collecting the ambient environmental data, and on the data processing server side, there is no need for it to manage the ambient environment sensors themselves. Moreover, since the vehicle itself is managed by the user, it is possible to reduce the load on data processing server 21 in collecting the ambient environment data. It is also possible on the user side, to have only required information passed to the user.

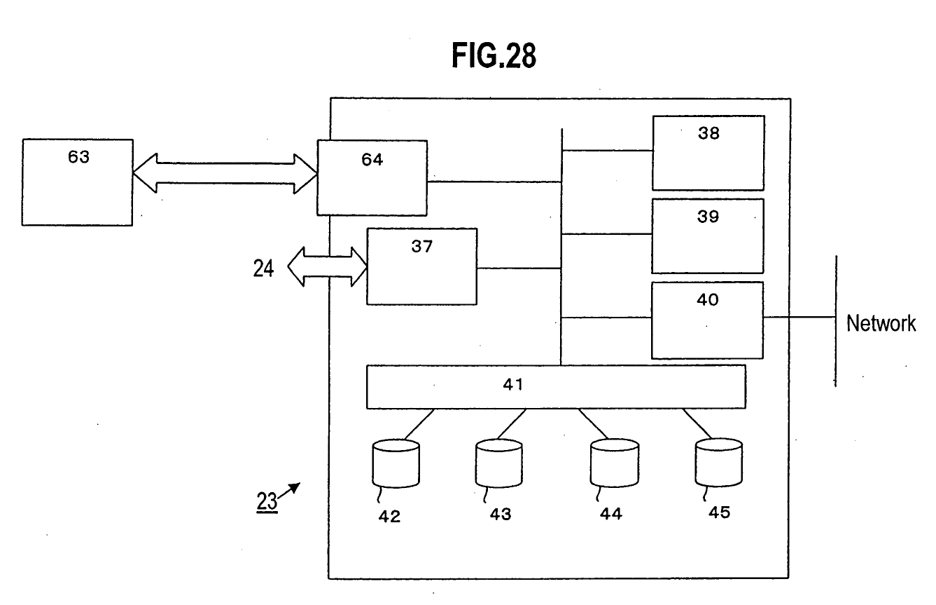

FIGS. 27 and 28 will illustrate the case in which the vehicle itself is not equipped with the hardware described in FIG. 25, to wit, a specialized device/equipment function unit 63. A user terminal device (e.g. wireless telephone) 23 such as was described using FIG. 7, etc., connects with an in-vehicle LAN such as special device/equipment function unit 63, and processing is performed as described in FIGS. 24 through 26.

As shown in FIG. 28 for the case when the user terminal device is wireless telephone 23, this wireless telephone, just as the user terminal device described in FIG. 7, is equipped with a MM input/output unit (not shown), sensing equipment communications unit 37, computer unit 38, memory unit 39, network communications unit 40, DB management unit 41, process program unit 42, sensing information DB 43, processing program DB 44, program data unit 45, as well as connector unit 64. Connector 64 is used to connect specialized devices/equipment function unit 63 (control unit 63h) to wireless telephone 23.

With this configuration for wireless telephone 23, as shown in FIG. 24, ambient environment data and position data can be acquired respectively from ambient environment sensors 60 and position data tags 61 and then transmitted to data processing server 21. It is further possible to acquire vehicle operational state information from specialized device/equipment function unit 63 and transmit it from wireless telephone 23 to data processing server 21. As a result, it is possible to perform the same types of processing as were described with reference to FIGS. 24 through 26.

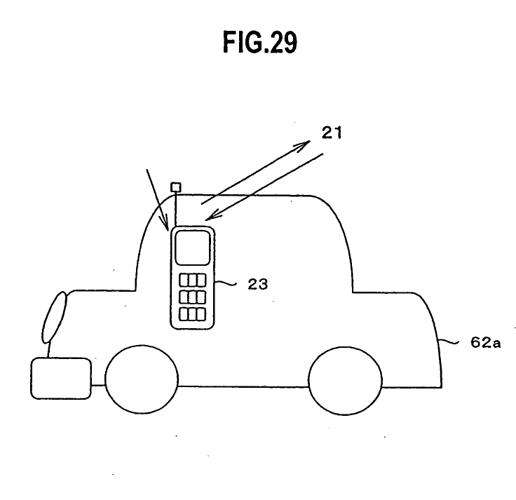

Also, as shown in FIG. 29, in the case of a user terminal device 23 not equipped with connector unit 64 (for example, a wireless telephone: to wit, a wireless telephone having the same hardware configuration shown in FIG. 7) carried by a user who boards vehicle 62a, it is possible to transmit the same ambient environment data and position data to data processing server 21 as was described in relation to FIGS. 24 through 26. As a result, it would be possible to obtain processed data regarding the vehicle's route, etc.

Further, although data processing server 21 can not automatically transmit the vehicle operational state information to data processing serer 21, it is possible to acquire the closest gas station, for example, by manually transmitting to data processing server 21 the data of fuel remaining inside fuel tank after checking the fuel remainder detector.

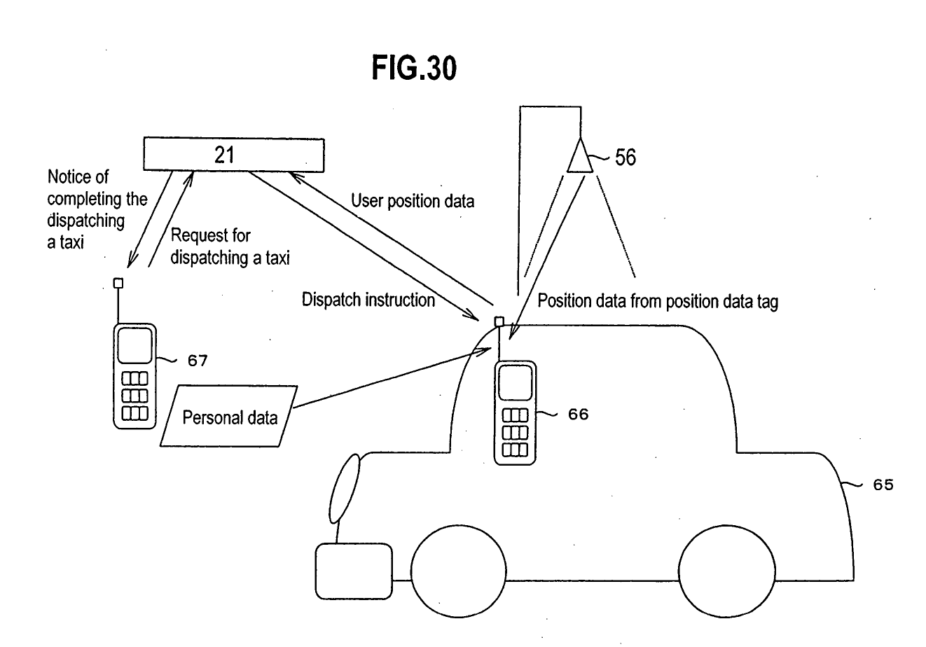

Next, an explanation will be provided for employing a user terminal device (e.g. a wireless telephone) to summons a taxi with reference to FIG. 30.

In the illustrated example, taxi 65 is equipped with the same kind of user terminal device that was described in FIG. 7 (e.g. a wireless telephone). In other words, the taxi driver is carrying a wireless telephone. Also, the user is carrying a wireless telephone of the same type described in FIG. 7. The explanation below uses reference number 66 for the taxi driver's wireless phone, and reference number 67 for the user's wireless phone.

At this point, if the user (taxi user) wants to get taxi 65, he uses his wireless telephone 67 to transmit the taxi dispatch request to data processing server 26 (a request to send a taxi) (In FIG. 30, the network has been omitted from the illustration). This taxi dispatch request includes the destination as well as the wireless phone number of wireless phone 67

This data processing server 21 is of the same hardware configuration as described for FIG. 8, and in the illustrated example, it functions as a taxi dispatch center. In sum, data processing server 21 dispatches taxis based upon taxi requests from users.

Using a procedure similar to that in FIG. 18, data processing server 21 could also be set up send and receive data with a separate taxi dispatching center (but for purposes of this explanation, data processing server 21 shall function as the taxi dispatch center).

As described above, each taxi wireless telephone 66 obtains position data from the position data tags (fixed data transmitter) 56, and when a taxi dispatch request is transmitted, this position data is transmitted from wireless telephone 66 to data processing server 21. In a similar manner, each taxi's wireless phone 66 receives position data from position data tag 56, and each taxi's wireless phone transmits its current position to data processing server 21. In other words, data processing server 21 has information on the positions of all of the taxies assigned to it, and it maintains and manages the taxis.

When data processing center 21 receives a taxi dispatch request from a user's wireless telephone 67 (which includes information about the location of the user), it searches on the positions of all taxies to find the taxi (i.e. wireless telephone 66) that is closest to the user's current location to which it transmits dispatch instructions. These dispatch instructions include the telephone number of the user's wireless telephone 67 and the user's location information. At the same time, data processing server 21 can transmit a message to wireless telephone 67 indicating that a taxi has been dispatched. This taxi dispatch message would include the telephone number of the taxi's wireless telephone 66, his vehicle number, etc.

When the dispatch indication has been completed, both the user and taxi driver can confirm their identities using their wireless telephones 66 and 67 before the user boards the taxi. For example, if the user's personal telephone number for his wireless phone 67 is transmitted to the wireless phone 66 of the taxi, the driver can confirm that he was the user who sent the dispatch request before allowing him to board the taxi.

Although the explanation for FIG. 30 assumed the user terminal device to be wireless phones, to wit, it was explained using a user terminal device configured as shown in FIG. 29, the taxi 65 may have the configuration shown in FIG. 25, or the configuration shown in FIG. 27 (or FIG. 28).

In the example shown in FIG. 30, it was possible to quickly dispatch the taxi that was closest to the user's location, and the user was able to get a vacant taxi very easily. Such a system would also allow the taxi driver to earn more money.

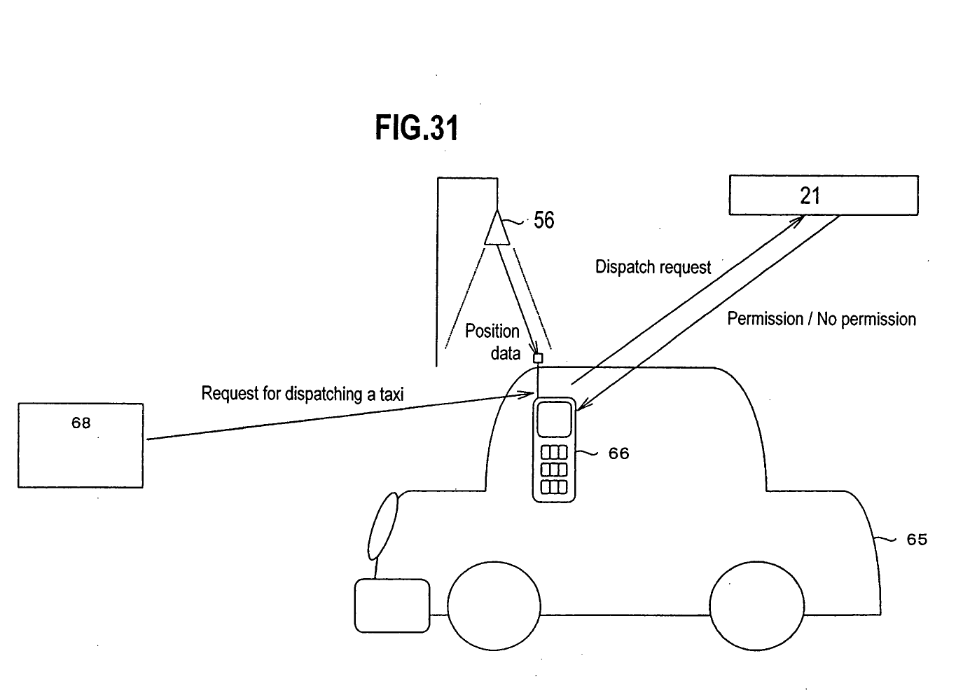

Further, FIG. 31 shows an example of a user himself having a data transmitter (fixed data transmitter). For example, the user could carry a card-shaped data transmitter. In this example, this data transmitter will be called a taxi ticket. This taxi ticket 68 is used as a data tag. Prerecorded on this data tag 68 is data about the individual user (the telephone number of his wireless telephone, etc., but this wireless telephone is not a user terminal device (it is merely a conventional wireless telephone)).

It would be possible to record data such as the destination on each taxi ticket at the time of its issuance. When the user used his taxi ticket, his personal data and destination would be transmitted as a taxi dispatch request (at this time, as previously described, the destination could be previously recorded on the ticket, or at the time it was used, it could be input onto taxi ticket 68). Then a taxi located in the same sensor field as taxi ticket 68 would receive on its user terminal device (e.g. wireless telephone 66) the taxi dispatch request.

In response to this taxi dispatch request, the wireless phone 66 of the taxi 65 that was the object of the ride request (dispatch request) would transmit a permission to dispatch request to data processing server 21 (taxi dispatch center). At this time, wireless telephone 66 would obtain position data tag 56 as position data, and in addition to transmitting the taxi's own current location to data processing server 21, it would also transmit the aforementioned destination data to data processing server 21.

At data processing server 21, when it receives the request to dispatch request from wireless telephone 66, it considers the current location information for the taxi and the destination information and decides to grant permission for the taxi to pickup the passenger. For example, when from the taxi's current position data and the pickup location data it was determined that the distance between the pickup location and the current location was close, predetermined rules could be applied (such as in the order of the taxi with fewest riders up to the current point in time) in determining the permission to grant ride request.

After the determination is made to grant the ride request to taxi 65, data processing center 21, in addition to transmitting the pick-approval to the taxi it selected, transmits pickup refusals to the other taxis. This pickup approval contains the above described personal data.

The taxi 65 receiving the pickup approval, can then confirm, based upon the personal information of the rider from his wireless telephone 66 that the dispatch request was associated with that particular user's wireless telephone (which is not a user terminal device but a conventional telephone), and then, the user can board the taxi.

The explanation provided for FIG. 31 employed wireless telephone 66 as a user terminal device, to wit, as the explanation associated with FIG. 29, the phone was used as the user terminal device. Taxi 65 may, however, use the configuration shown in FIG. 25, or further, the configuration shown in FIG. 27 (and FIG. 28).

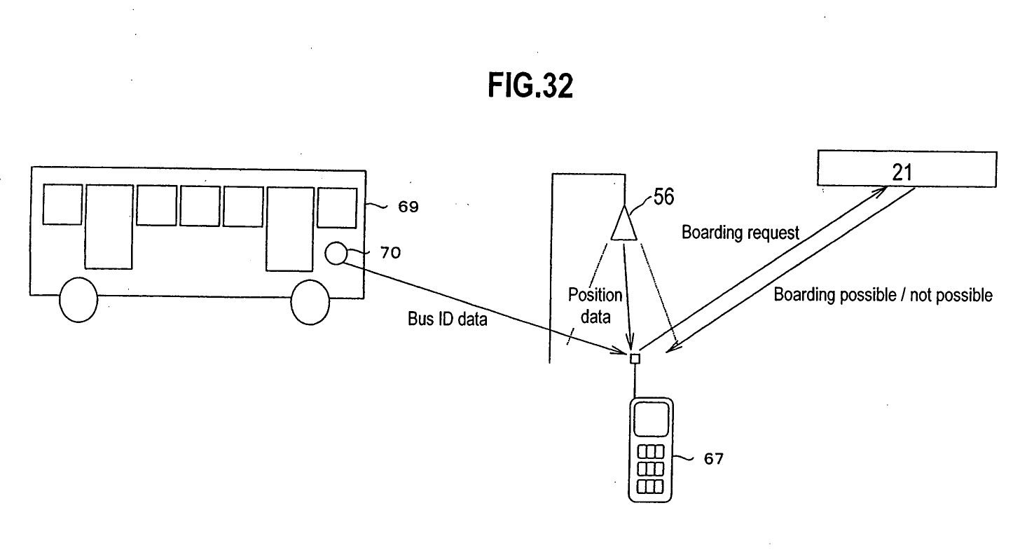

FIG. 32 will be referenced to describe a user terminal device (e.g. wireless telephone 67) for the user to board a bus.

Bus 69 is equipped with fixed data transmitter 70, and this fixed data transmitter 70 transmits data on the bus (e.g. route name and destination, etc. which will be referred to below as “bus data”). When a user desires to ride a bus, he starts wireless telephone 67 and inputs his desired destination.

This causes the user's current location to be obtained from position data tag 56 as user location information. Wireless telephone 67 in the bus, being with the same sensor field, transmits the bus data from fixed data transmitter 70 to wireless telephone 67.

When the bus data is received, wireless telephone 67 transmits the aforementioned destination information, the current location of the user, and the bus information as a bus boarding request to data processing server 21 (the network is not shown in FIG. 32), which in this example, functions as a bus center. Thus, the data processing server performs bus confirmation in response to the user's bus boarding request.

Using a procedure similar to that described for FIG. 18, data processing server 21 could also send and receive data with a separately established bus operations center, and perform bus confirmations as above (but in the explanation below, data processing center 21 will be described as functioning as the bus operations center.

When data processing server 21 receives the bus boarding request (destination information, user location, and bus information), it determines whether it is possible to board the bus in question. In other words, based upon the destination and bus information, it determines if the bus is going to that destination. If the bus is not going to the requested destination, boarding is not possible, and a message to that effect is sent to portable telephone 67. On the other hand, if the bus does go to that destination, a message is sent to portable telephone 67 indicating it is possible to use that bus.

Further, data processing server 21 can also determine, based upon the destination data and the user location data, whether or not at the current point in time, the bus going to the desired location has already passed. (in other words, that a bus going to the user's destination will not come along), and if so, it transmits a message to wireless telephone 67.

In this manner, the user is easily able to obtain bus information for his desired destination by using the bus operations system; even if he is going to an unfamiliar place, there will be no confusion about which bus to board.

Area of Utility to the Industry

As has been described above, the present invention facilitates the transmission from a data transmitter of predetermined fixed data and/or sensing data, the receipt by a user terminal device of located in a predetermined space of the fixed data, and the transmission via a network by the terminal device of the fixed data as acquired data to a data processing server along with a data processing request, in a manner such that the data processing server can generate and transmit back to the terminal device, processed data based upon the processing request and the acquired data without any requirement for the data processing server to oversee or manage sensing data, etc, to thereby make it possible to reduce the load upon the data processing server.

Further, making it possible for the terminal device to function as a sensor terminal for the collection of data, has the effect of allowing data to be collected without the data processing server employing a specialized system such as a sensor terminal. Additionally, since there is no need for a specialized system, universality is improved, and it can be applied very easily to a variety of data provision systems.

Further still, since there is no need for the data processing server to manage sensors, sensor terminals etc. for the measurement of physical phenomena or physical quantities, the invention is effective in reducing the load upon the data processing server. To wit, the data processing server must only manage acquired data that has been transmitted to it by a terminal device; it does not have to manage all sensor data. In other words it only must mange the data required by the terminal device.

Further, because the terminal device transmits acquired data and the data processing server transmits back processed data, the invention effectively makes it possible to appropriately obtain all of the required data (processed data).

1. A terminal device provided in a predetermined sensor field, comprising:
a terminal transmission means that can transmit, via a network, to a data processing server, an acquired data acquired from receipting a sensing data comprising pre-specified fixed data and/or sensed physical phenomena or physical quantities within said sensor field; and
a terminal reception means that can receive a processed data processed based upon said acquired data from said data processing server.

2. The terminal device according to claim 1, further comprising a notification means that makes notifications on said acquired data and said processed data.

3. The terminal device according to claim 1, further comprising a downloading means to download a special processing program from said data processing server when said acquired data requires said special processing program to thereby process said acquired data for transmitting to said data processing server.

4. A data processing server, comprising:
a server reception means that can receive an acquired data from the terminal device according to claim 1;
a server processing means that can generate a processed data by processing said acquired data; and
a server transmission means that can transmit said processed data to a terminal device.

5. The data processing server according to claim 4, further comprising a fee assessment means that computes an amount of a fee to be charged based upon said processed data for transmitting to said terminal device.

6. The data processing server according to claim 5, wherein said fee assessment means can accumulate the amounts of fees assessed for each of said terminal devices.

7. The data processing server according to claim 5, wherein said fee assessment means notifies said terminal device that a fee is required prior to completing the generation of said processed data if said fee assessment means determines said generation of said processed data is chargeable.

8. The data processing server according to claim 4, wherein, when generating said processed data based upon said acquired data from said terminal device, said server processing means receives a requisite information from another system in order to execute a process request sent from said terminal device, then generates said processed data based upon said acquired data and said required information.

9. The data processing server according to claim 4, further comprising a search means to search a special processing program among a plurality of processing programs when said data processing server receives a download request from the terminal device according to claim 3, and said searched program is downloaded to said terminal device in response to said downloaded request.

10. An information provision system, comprising:
a fixed data transmitter, provided in a predetermined sensor field, that transmits pre-specified fixed data;
a terminal device that receives said fixed data from said fixed data transmitter when said terminal device moves into said sensor field, and then transmits said fixed data via a network as an acquired data, and
a data processing server which provides a processed data to said terminal device, processed based upon said data acquired and a data processing request received from said terminal device.

11. The information provision system according to claim 10, further comprising a sensing data transmitter which can transmit a sensing data acquired by sensing physical phenomena or physical quantities to said terminal device when said terminal device moves into said sensor field, so that said terminal device may forward said sensing data as said acquired data to said data processing server.

12. The information provision system according to claim 10, wherein said terminal device may be a first and a second terminal devices, said first terminal device transmits said data processing request and a first acquired data as a first set of acquired data to said data processing server, said second terminal device transmits a second acquired data to said data processing server, then said data processing server, based upon said processing request and said first set of acquired data, provides said processed data in response to said second acquired data, and transmits said processed data to said second terminal device.

13. The information provision system according to claim 10, wherein said fixed data transmitter is installed in a mobile apparatus.

14. An information provision method, comprising:
a first step to receive a fixed data when a terminal device moves into a predetermined sensor field;
a second step to transmit said fixed data as an acquired data via a network by said terminal device; and
a third step to receive said acquired data, then generate a processed data based upon the said acquired data and a processing request from said terminal device, and provide said processed data to said terminal device.

15. The information provision method according to claim 14, wherein said terminal device receives a sensing data of physical phenomena or physical quantities in said first step, and then said terminal device transmits said sensing data as said acquired data to said data processing server in said second step.

16. A data processing program for a computer which functions in a manner characterized in that a terminal transmission means receives a predetermined fixed data and/or a sensing data of physical phenomena or physical quantities as an acquired data within a predetermined sensor field, and transmits said acquired data via a network to a data processing server, and a terminal reception means to receive the processing results from said data processing server that processed said acquired data.

17. A recordable media upon which a data processing program is recorded that is readable by a computer, said data processing comprising:
a first step to receive a fixed data when a terminal device moves into a predetermined sensor field;
a second step to transmit said fixed data as an acquired data via a network by said terminal device; and
a third step to receive said acquired data, then generate a processed data based upon the said acquired data and a processing request from said terminal device, and provide said processed data to said terminal device.
